(19) United States
(12) Patent Application Publication
(10) Pub. No.: US 2026/0296311 A1
(43) Pub. Date: Oct. 1, 2026

(54) SYSTEMS AND METHODS FOR DETECTING AND IDENTIFYING HAZARDOUS MATERIALS AND HAZARDOUS MATERIAL EVENTS

(71) Applicant: Adeia Guides Inc., San Jose, CA (US)

(72) Inventors: Serhad Doken, Bryn Mawr, PA (US); Ning Xu, Irvine, CA (US); Charles Dasher, Lawrenceville, GA (US)

(21) Appl. No.: 19/092,891

(22) Filed: Mar. 27, 2025

(51) Int. Cl. B60Q 9/00; B60W 30/09; G08B 21/18

(52) U.S. Cl. CPC B60Q 9/008; B60W 30/09; B60W 2420/40; B60W 2554/802; B60W 2556/00; B60W 2556/10; G08B 21/182

(57) ABSTRACT

Systems and methods are described herein for detecting and identifying hazardous material on a roadway and causing a vehicle to perform an action in response. The disclosed methods use one or more sensor devices (e.g., an IR camera) to capture data associated with material located within a surrounding environment of the vehicle. The detected material may be determined to be hazardous by analyzing an image of the material captured by the sensor devices. Based on a determined size and location of the hazardous material, the system may determine that a hazardous material event is imminent (e.g., an interaction between one or more vehicles and the material). The vehicle then performs an action to ameliorate the hazardous material event, such as implementing one or more suggested driving maneuvers to avoid an impact with the hazardous material and/or notifying nearby drivers of information related to the hazardous material event.

### BACKGROUND

The present disclosure relates to identifying hazardous material on a road or path ahead of a vehicle and determining an action to be performed based, for instance or at least in part, on classifying the hazard and computing a potential impact on the vehicle.

### SUMMARY

Hazardous materials are essential to a nation's economy and its citizens. For example, large sectors of the United States (U.S.) economy, including agriculture, manufacturing, construction, mining, medical and sanitary services utilize hazardous materials, or materials that may present a hazard if not handled appropriately or that are involved in a spill or accident, for example. In other sectors, hazardous materials fuel our vehicles, fight viruses and bacteria, as well as heat and cool homes. As everyday needs demand a steady supply, millions of tons of flammable, corrosive, poisonous, and radioactive materials are transported daily in the U.S. However, because of their physical, chemical, or nuclear properties, hazardous materials may pose a threat to public safety or the environment during transportation on roadways.

Hazmat shipments account for 12% of all freight tonnage shipped within the U.S., which equates to roughly 3.3 billion tons of hazardous materials shipped every year, worth an estimated $1.9 trillion. Overall, there are around one million shipments of hazardous materials every day in the U.S. In fact, commercial motor vehicles transport the largest volume of hazardous materials through the U.S. transportation system. While the majority of hazardous material cargoes make it to their destinations safely, some incidents inevitably occur. Most incidents involve accidental releases of material, but there can be more serious threats to life or property. For example, such hazmat spills may cause a traffic accident or the spill may occur as the result of a traffic accident.

Vehicular fluid spills are releases of materials that are used in a vehicle's operation (e.g., fuel (diesel or gasoline), radiator coolant (ethylene glycol), transmission fluid, hydraulic fluid, brake fluid, windshield-washer fluid, and battery acid). Other less common materials that are used in vehicles include ethanol, propane, and compressed natural gas (CNG), although propane and CNG quickly transform into their gaseous states when released. In most cases, the size of the release is usually small and limited to the amount used in vehicle operations.

A hazardous materials cargo spill is a release of a substance or material capable of posing an unreasonable risk to health, safety, or property when transported for commercial purposes. Unlike a vehicular fluid spill, a variety of other factors dictate the size and nature of the spill, such as the type of material being transported, the original load size, the physical properties of the material and the amount of damage to the transporting vessel. In some cases, spill-prone hazmat materials, as well as other accident-prone materials, are flammable and combustible liquids, (natural) gases, oxidizers and/or organic peroxides.

Data from the Department of Transportation Hazardous Materials Safety Administration indicates that there were 3,391 incidents during transportation involving hazardous cargo in 2017. These accidents resulted in two hospitalizations and six fatalities and caused nearly $33 million in damages. Fatalities resulting from hazardous material transportation are rare and in 2018, only three fatalities were recorded. However, injuries are more common. For example, in 2018, 101 people suffered injuries in an accident involving hazardous materials. While the number of injuries and fatalities resulting from hazardous material transportation has been on the decline over the past few years, the number of incidents remains high. For example, the number rose again in 2018 to 15,970 incidents.

Motor vehicle accidents resulting from spills of hazardous materials can be unpredictable in nature and may lead to disastrous consequences. For example, oil spills occur on the roads when tankers, oil trucks, and oil rigs release liquid petroleum hydrocarbon into the environment. When spilled over a large enough area, an oil spill can cause one or more motorists to lose control of their vehicles due to the slippery road, resulting in horrifying multi-vehicle collisions. Light oil spots or stains on roadways may be encountered from regular consumer vehicles as well. For example, unmaintained older vehicles can leak various vehicle fluids. Additionally, oil may be spilled onto road surfaces as a result of mechanical failures, such as leaking or from improper handling of the vehicle during transportation. Besides being slippery for the average vehicle, oil is a highly flammable and toxic substance, which increases the risk of explosions and burns when it spills out, as well as exposing victims to the harmful substances that the oil contains.

Moreover, in general, it is difficult for a driver in motion to spot any sort of fluid spill, let alone assess the size or type of the spill. This being difficult enough in broad day light, it is almost impossible to be detected by humans at night. Further, red, green, and blue (RGB) cameras, when used in isolation, may be error prone on bright sunny days or in dark conditions.

Therefore, there exists a need to accurately detect and classify a potentially hazardous condition on a driving path of a vehicle and perform appropriate action(s) based on such detecting and classification. To help address this issue, the systems, vehicles, and methods disclosed herein provide a system that is capable of determining the size and location of hazardous material in the path of a vehicle, detecting the occurrence of an imminent hazardous material event, assessing the potential risk to a motor vehicle and causing the vehicle to perform an action in order to avoid or mitigate the hazardous material event. Furthermore, the example systems and methods disclosed herein relate to providing one or more suggestions for a vehicle or a driver of a vehicle to perform in order to avoid the hazardous condition, as well as generating an alert to an occupant of the vehicle or a different vehicle.

To further help address problems of the above approaches, systems and methods are disclosed herein for detecting, using one or more sensors, material within a surrounding environment of the vehicle. For example, the system may determine that the material is a hazardous material in a roadway. In some embodiments, once a material is detected, an infrared (IR) image of the material is analyzed to determine whether the material is a hazardous material. For example, the IR image may include thermal data based on the temperature of the material, which may indicate that it is of a hazardous type or category. As a further example, an IR camera is capable of measuring radiation emitting from various materials, which may be converted into thermal data. In some embodiments, a size and a location of the hazardous material is determined. For example, the size and location of the hazardous material may be determined based on a vehicle's distance to the material and spatial resolution value of the one or more sensors. In some embodiments, based on determining that the material is a hazardous material, and the size and the location of the hazardous material, the system determines an imminent hazardous material event, which may indicate a potential impact of the hazardous material on or with the vehicle. In some embodiments, the system causes the vehicle to perform an action to ameliorate the hazardous material event. For example, the vehicle may perform accident prevention or avoidance measures based at least in part on the computed potential impact.

In some embodiments, the system determines that the material is a hazardous material based on extracting material data by analyzing the IR image of the material. For example, the extracted material data may indicate that the material is associated with certain material attributes or characteristics (e.g., thermal data) indicating that it is hazardous. For example, the extracted material data may be compared to a database of material types in order to determine a material type for the material depicted in the IR image. In some embodiments, based on determining the material type for the material depicted in the IR image, the system determines that the material is a hazardous material.

In some embodiments, the extracted material data is compared to the information in the database of material data by identifying the material characteristics associated with extracted material data. In some embodiments, the system determines a correspondence between characteristics based at least in part on comparing the material characteristics to known material characteristics maintained by the database. In some embodiments, the correspondence of characteristics is compared to a threshold value. For example, the threshold value may represent a minimum number of matching characteristics to facilitate a prediction of sufficient confidence about the nature of the material. In some embodiments, the system determines the material type based at least in part on the match of characteristics meeting or exceeding the threshold value.

In some embodiments, the action performed by the vehicle or occupant comprises generating for display an alert to the driver or occupant of the vehicle. For example, generating the alert may include generating for display one or more of a suggested driving action (e.g., a velocity change, a driving track (lane) change, a steering wheel angle change, activating an anti-lock breaking system (ABS) or suspension system momentarily, adjusting the inter-vehicle distance, or a position change) for the occupant to perform in order to avoid an impact with the hazardous material or generating for display an augmented visualization of extracted material data (e.g., which may be displayed via a heads-up display (HUD) of a dashboard). In some embodiments, generating the alert comprises causing output of an audio, visual, haptic or textual indication of the hazardous material.

In some embodiments, one or more of another sensor is used instead of or in combination with an IR camera to determine a distance between the hazardous material and the vehicle and to determine the size and the location of the hazardous material. For example, the below techniques consider the implementation of RGB and metalens camera devices.

In some embodiments, the vehicle is an autonomous vehicle with self-driving capabilities, and causing the vehicle to perform the action comprises causing the autonomous vehicle to automatically navigate away from the hazardous material. For example, the autonomous vehicle may automatically perform one or more actions to avoid the potential impact with the hazardous material.

In some embodiments, causing the vehicle to perform the action comprises transmitting a notification associated with the location of the hazardous material to one or more other vehicles that are near the vehicle that is detecting the hazardous material. For example, the vehicle may be associated with one or more navigation systems (e.g., Google™ or Apple™ maps applications) and may transmit the IR image, extracted material data or the size and the location of the hazardous material to the navigation systems, which distribute the information to other nearby vehicles that are also associated with the navigation system. In some embodiments, only the particular vehicles within a threshold vicinity or distance of the vehicle detecting the hazard are notified of the existence hazardous material, as those particular vehicles have the highest likelihood of encountering the hazardous material.

In some embodiments, the system utilizes a machine learning (ML) model to determine whether the material depicted in the IR image is hazardous or not. For example, the ML model may be trained using thermal images, and the system inputs thermal image data to the ML model. In some embodiments, based on the thermal image data input to the ML model, the ML model is configured to output an indication of whether the material is hazardous.

In some embodiments, based on computing the size and location of the hazardous material, the system computes the risk of a potential encounter with the hazardous material. For example, the system may access a dataset of crowdsourced historical data, which describes various hazardous materials respectively associated with one or more possible risk conditions. In some embodiments, a level of risk that the hazardous material poses to one or more portions of the vehicle is computed based at least in part on the dataset, the size and the location of the hazardous material.

In some embodiments, determining that the material is a hazardous material is further based at least in part on a detected environmental condition (and/or a geographical location of the material and/or a time of year in a particular geographical location) of the surrounding environment of the vehicle. For example, if a vehicle is being operated in Arizona and/or in the summer months, the system may determine that any detection of ice on a road is considered a false detection.

In some embodiments, the vehicle experiences a direct encounter with the hazard. For example, a vehicle may not be able to navigate away from the hazardous material due to heavy traffic or traveling at high speeds or detecting the hazardous material at a time that is too late to partially or completely avoid such material. In some embodiments, the system performs a further analysis of risk to the vehicle based on additional data obtained by the direct encounter with the hazard. In some embodiments, aspects of the additional analysis are shared with other nearby vehicles.

In some embodiments, if a first risk assessment does not result in detecting a major hazard, the system may perform a second computation to determine future risks that may be relevant for the vehicle once the vehicle passes the hazard. For instance, if the system determines that running over the hazmat material is unlikely to be a significant concern, the system may perform a further analysis as if, for example, fuel contact with tires had indeed occurred. If such contact occurred, there may still be a fire hazard risk since the moving vehicle comprises components that have high heat surfaces.

### BRIEF DESCRIPTION OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

The embodiments herein may be better understood by referring to the following description in conjunction with the accompanying drawings, in which like reference numerals indicate identical or functionally similar elements, of which:

FIG. 1 is an illustrative system for detecting an imminent hazardous material event in relation to a vehicle and performing an action to ameliorate the hazardous material event, in accordance with some embodiments of the disclosure;

FIG. 2A is an illustrative graph describing the application of various wavelengths captured by different camera devices, in accordance with some embodiments of the disclosure;

FIG. 2B is an illustrative example of images captured using different camera devices, in accordance with some embodiments of the disclosure;

FIG. 3 is a flowchart of the process for detecting hazardous material and computing a size of the hazard, in accordance with some embodiments of the disclosure;

FIG. 4 is a flowchart of the process for determining whether to perform a risk assessment for a detected hazard based on known hazard patterns, in accordance with some embodiments of the disclosure;

FIG. 5 is a flowchart of the process for performing an assessment of potential risk to a vehicle based on a detected hazard, in accordance with some embodiments of the disclosure;

FIG. 6 is a sequence diagram illustrating the process of performing a vehicle action in response to detecting a hazard, in accordance with some embodiments of the disclosure;

FIG. 7 is an illustrative example of vehicle components used to detect a hazardous material event and perform an action to ameliorate the event, in accordance with some embodiments of the disclosure;

FIG. 8 depicts illustrative devices and systems for enabling a vehicle to detect hazardous material and perform an action to avoid an encounter with the hazardous material, in accordance with some embodiments of the disclosure;

FIG. 9 depicts devices and systems including a server, a communication network, and computing devices for performing the methods and processes described herein, in accordance with some embodiments of the disclosure;

FIG. 10 is a flowchart of the process for detecting hazardous material and performing an action to avoid an encounter with the hazardous material, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

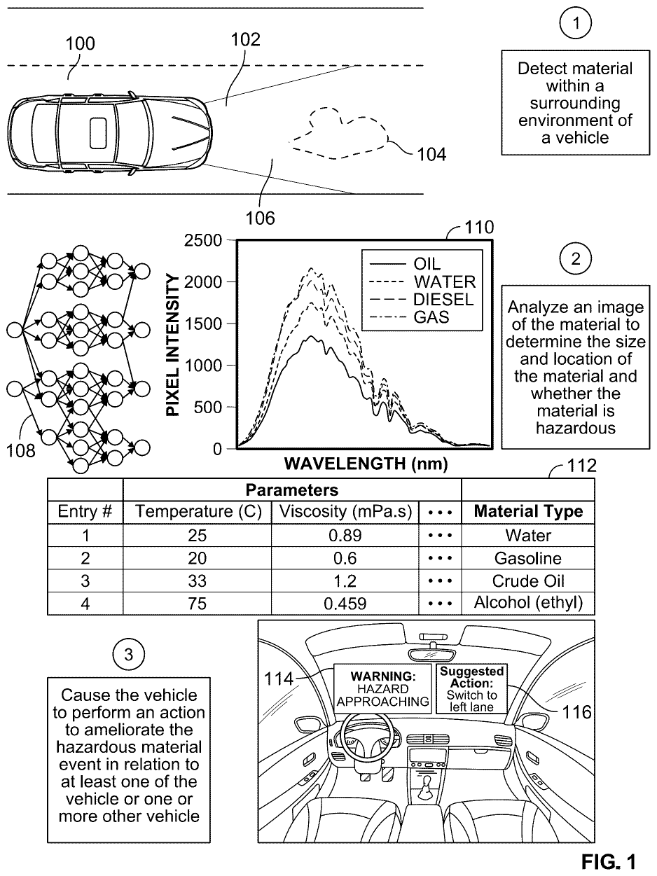

FIG. 1 is an illustrative system for detecting an imminent hazardous material event in relation to a vehicle and performing an action to ameliorate the hazardous material event, in accordance with some embodiments of the disclosure. The various examples and embodiments described herein are applied to vehicles, alone or in combination with other devices (e.g., a server), detecting (and performing ameliorative actions in relation to) one or more hazardous materials on a driving path of a vehicle. The driving path of the vehicle may include, for example, a road, street, roadway, parkway, highway, bridge, tunnel, driveway, parking lot, garage or parking garage, off-road environment, and/or any other suitable type of terrain or driving location that a vehicle may traverse or park in, but it should be appreciated that these techniques may be applicable to other types of objects or obstructions that may pose a threat to a part of a vehicle. For example, the techniques and systems described herein may be used to detect the presence of, and depth of, and/or other characteristics of a pothole, and may perform an ameliorative action to avoid or warn the vehicle occupant and/or occupants of other nearby vehicles of the pothole. In some embodiments, the driving path of the vehicle is behind the vehicle (e.g., if the vehicle is traveling in reverse or has the rear gear engaged). In some embodiments, the driving path of the vehicle has a slope or inclination. In some embodiments, the systems and techniques described herein may be employed in any other suitable setting, e.g., a factory or warehouse that may be employing robotics or other vehicles to transport items and/or take inventory of items, and such vehicles may detect a hazardous material in the factory or warehouse.

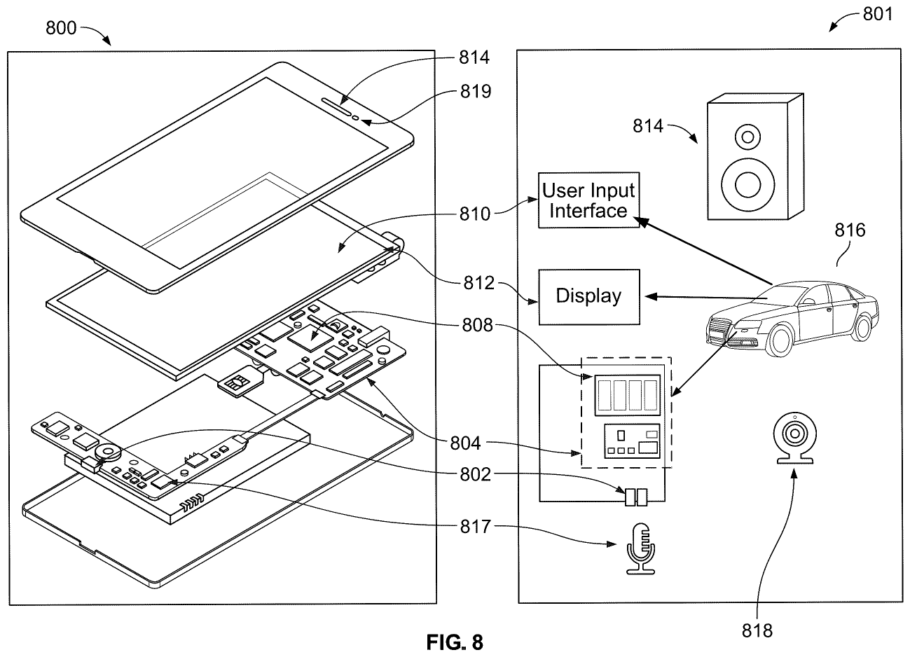

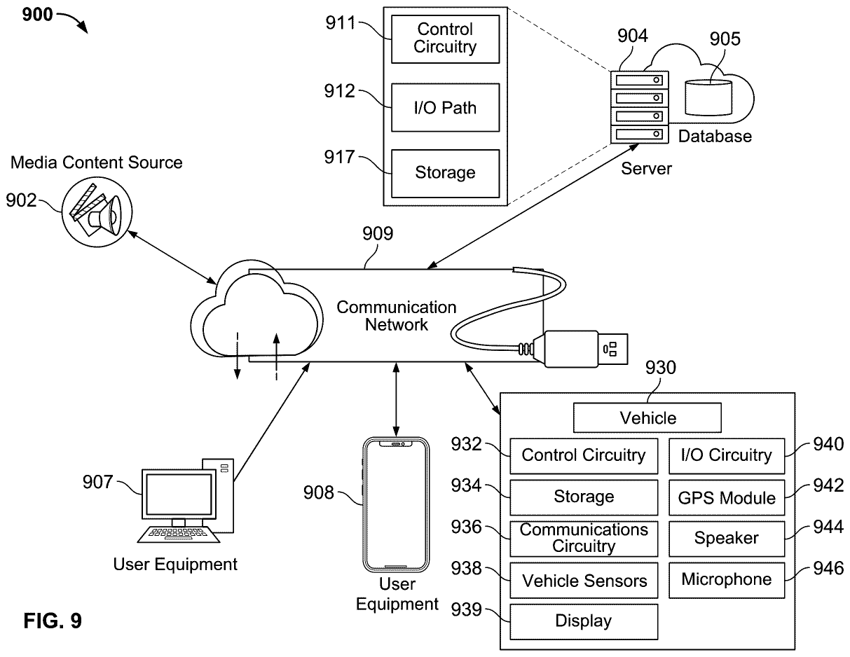

The techniques and systems described herein may be implemented, at least in part, using sensors, vehicles, servers, databases, networks, and/or other devices capable of capturing and analyzing video or image data of a surrounding area of a vehicle, such as one or more sensors 102 of FIG. 1. For example, the systems described herein may be implemented, at least in part, using servers associated with databases of information related to hazardous materials, such as database 112 of FIG. 1. In some embodiments, database 112 may be stored locally, e.g., at vehicle 100. In some embodiments, vehicle 100 is vehicle 816 or vehicle 930 of FIGS. 8-9, respectively. The various techniques described herein may be executed by control circuitry (e.g., 911, as further described in relation to FIG. 9) and/or by one or more remote servers (e.g., server 904 of FIG. 9 and/or media content source 902 of FIG. 9), and may utilize storage devices (e.g., database 905 of FIG. 9), at or distributed across any of one or more other suitable computing devices, in communication over any suitable number and/or types of networks (e.g., the internet). In some embodiments, applications, servers and/or devices comprise or employ any suitable number of displays, sensors or other devices, such as those further described in relation to FIGS. 8 and 9, or any other suitable software and/or hardware components, or any combination thereof. In some embodiments, the control circuitry is configured to execute the functions of the applications based on instructions stored in non-transitory memory (e.g., non-transitory memory or storage 808 of FIG. 8, and storage 917 of server 904 in FIG. 9).

As vehicles travel along a roadway, there is a risk of encountering various materials that may be on the surface of the roadway (e.g., material 104 of FIG. 1). For example, material on a roadway may be a substance, such as water, which is generally harmless in small amounts and while it remains in liquid form. As a further example, the material on the surface of a roadway may be a more hazardous substance, such as oil or gasoline, that poses a fire risk if ignited and may have a greater potential to cause a vehicle to slip compared to water.

In some embodiments, vehicle 100 is a motor vehicle traveling along a roadway. In some embodiments, vehicle 100 is a passenger car, minivan, truck, motorcycle, commercial vehicle, a train, a boat, a scooter, a bicycle, and/or any other mode of transportation capable of encountering hazardous material. In some embodiments, vehicle 100 may be an aerial vehicle, e.g., a drone, helicopter, or an airplane, configured to capture images of a road from above, analyze such images for hazardous material, and/or transmit such images for analysis. In some embodiments, vehicle 100 is one or more sensors installed near or above a roadway (e.g., such as on a building, light pole, overpass, traffic lights, traffic signs, etc.). In some embodiments, vehicle 100 utilizes an advanced driver assistance system (ADAS), which is a collection of technology features designed to enhance the safety of the driver and vehicle, and improve driving comfort. For example, an ADAS may comprise one or more safety features, such as collision avoidance and warning systems, lane assistance systems, adaptive cruise control, blind spot monitoring, traffic sign recognition, driver monitoring systems (e.g., to detect fatigue or distraction) or parking assistance. In some embodiments, vehicle 100 is an autonomous vehicle (AV) or implements partial AV functions such as self-driving, decision-making artificial intelligence (AI), vehicle-to-everything (V2X) communications (e.g., for communicating with other vehicles, pedestrians and infrastructure connected to a network to enhance safety and coordination), autonomous navigation and mapping, and/or any other suitable functionality. For example, as indicated by the standards of the Society of Automotive Engineers (SAE), there are various levels of vehicle autonomy, such as level zero: no automation (e.g., human driver fully controls the vehicle), level one: driver assistance (e.g., adaptive cruise control and lane-keeping assistance), level two: partial automation (e.g., vehicle can steer and brake but requires driver oversight), level three: conditional automation (e.g., vehicle can drive itself in certain conditions, but a human must take over if needed), level four: high automation (e.g., fully autonomous in predefined areas but requires a human control in some situations) and level five: full automation (e.g., vehicle completely self-drives in all conditions with no driver intervention needed).

In some embodiments, vehicle 100 is equipped with one or more sensors or devices, such as, for example, sensor 102. In some embodiments, sensor 102 comprises one or more image sensors (e.g., included in a camera or camera array) capable of capturing images or videos or a surrounding area of vehicle 100. In some embodiments, sensor 102 is one or more series of camera devices or sensors. For example, sensor 102 may utilize a series of cameras located on exterior and/or interior portions of a vehicle. Images captured by the one or more cameras may be stitched together to generate a complete or substantially complete image or view of the entire surrounding environment of a vehicle. In some embodiments, sensor 102 is associated with a field of view (FOV) (e.g., FOV 106 of FIG. 1) and is capable of capturing images or videos of the surrounding environment within the FOV.

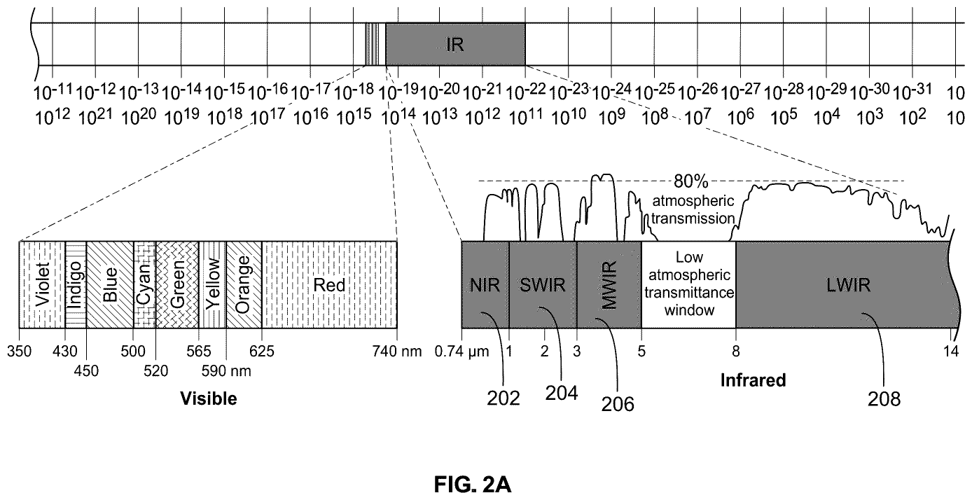

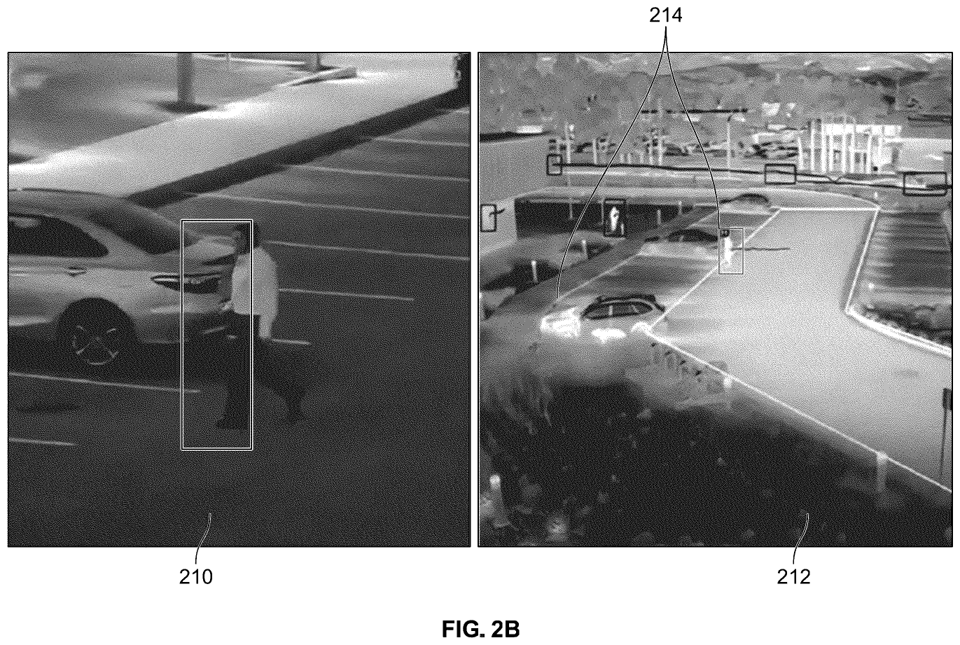

In some embodiments, vehicle 100 is moving along a roadway when material 104 is detected. In some embodiments, vehicle 100 is stationary when material 104 is detected. For example, material 104 may appear on a roadway as the result of a commercial transportation vehicle spilling excess cargo onto the surface of the roadway, or another vehicle spilling or leaking one or more vehicle fluids (or other hazardous materials) onto the roadway. In some embodiments, detecting that material is spilling or leaking from another vehicle is used to trigger the process of detecting and identifying the material. In some embodiments, detecting material on the surface of a roadway includes the action of recognizing that an object is present. In some embodiments, material 104 is within FOV 106 of sensor 102, and sensor 102 captures an image of the surrounding environment of the vehicle within FOV 106. In some embodiments, sensor 102 is configured to continuously monitor the surrounding environment of vehicle 100 to identify objects or materials. Additional information related to the detection of materials is described in relation to FIGS. 2A-2B.

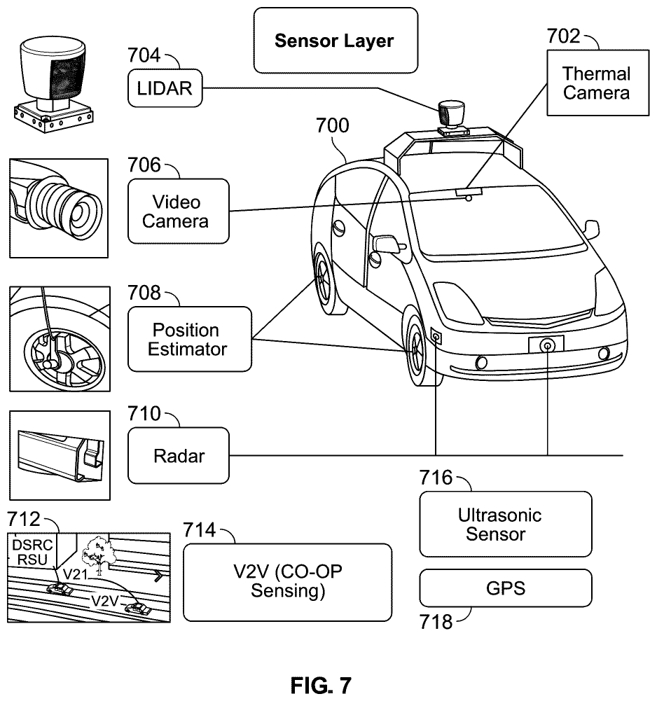

In some embodiments, the system analyzes one or more images or videos of the surrounding environment captured by sensor 102. In some embodiments, depending on the type of camera device or sensor being used, portions of the one or more images or videos of the surrounding environment are associated with various characteristics. For example, if an IR camera is used to capture images of a surrounding environment of a vehicle, the captured images may indicate a temperature of respective portions of the image. As a further example, using other types of camera devices (e.g., as described in relation to FIGS. 2A-2B and 7), captured images may indicate the wavelength or viscosity of portions of the image. In some embodiments, based on analyzing the one or more images or videos of the surrounding environment of vehicle 100, material 104 is detected.

In some embodiments, based on the image data analyzed by the system, the system classifies material 104, which is depicted in the one or more captured images or videos of the surrounding environment of vehicle 100. In some embodiments, classification comprises identifying the detected material as one of a plurality of known types of materials. In some embodiments, the system extracts the data describing material 104 from the one or more captured images or videos. For example, the one or more captured images or videos may include various image elements (e.g., bright white spots in an IR image), which can be identified by the system, and may be indicative of one or more values of one or more parameters of the material (e.g., temperature, viscosity and/or wavelength) of the image element.

In some embodiments, the system compares the data extracted from the one or more captured images or videos to a database of known material types (e.g., database 112 of FIG. 1). For example, database 112 may store characteristics of non-hazardous materials and hazardous materials, for comparison to characteristics of a currently detected material. In some embodiments, database 112 comprises a plurality of material signatures respectively associated with material characteristics or parameters (e.g., temperature, viscosity and/or wavelength). In some embodiments, the material signatures of database 112 indicate a type of material associated with a respective signature. For example, the system may compare the thermal data of a captured image to known thermal signatures of commonly encountered hazmat categories. As a further example, database 112 may maintain information related to signatures of known materials, such as transmission fluid, gasoline or diesel oil.

In some embodiments, object classification through black-and-white thermal imaging is performed by implementing image-detection algorithms traditionally used with colored-vision camera images. In some embodiments, this process involves collecting and labeling a thermal image dataset, and training machine learning model 108 at least in part using such data, for material detection inferencing. Machine learning model 108 may comprise, for example, convolutional neural networks (CNNs), CNSS (region-based CNN), and/or any other suitable machine learning models. In some embodiments, the performance of machine learning model 108 is improved by augmenting a limited thermal data set with readily available RGB camera images, such that the RGB camera images and thermal images supplement each other during training. In some embodiments, the object detection accuracy of machine learning model 108 is increased by receiving inputs corresponding to different hazmat parameters, such as lighting, hazmat/fluid types, surface types (e.g., asphalt, gravel, dirt), temperature and precipitation, among other suitable parameters. In some embodiments, machine learning model 108 is trained based at least in part on these parameters for more efficient inferencing.

In some embodiments, material 104 exhibits distinct thermal image patterns due to the differences in thermal properties between material 104 and the surface of the roadway. For example, since oil is thicker than an asphalt surface, portions of a captured image depicting the oil may appear with distinct thermal patterns (e.g., as described in relation to FIGS. 2A-2B). As a further example, oil typically has a lower thermal conductivity than asphalt, which can lead to noticeable temperature differences when viewed through thermal imaging. In some embodiments, areas affected by material 104 may appear cooler or warmer compared to surrounding areas, depending on the time of day (e.g., dropping temperatures after midnight) and certain environmental conditions (e.g., weather and air conditions). In some embodiments, the system leverages thermal segregation techniques to identify and compare detected material patterns with known signatures for known environmental conditions. In some embodiments, the pixel density for a set of material data is described in the form of a graph (e.g., graph 110). In some embodiments, the x-axis of graph 110 depicts a range of wavelength values, and the y-axis of graph 110 depicts a pixel intensity value for each wavelength value. In some embodiments, graph 110 depicts the pixel intensity of known materials, which may be compared to extracted image data in order to identify a material depicted in the image. In some embodiments, by analyzing the thermal image, the system can infer the viscosity of the detected material.

In some embodiments, the image characteristics of a captured image are compared to the known image data and/or pixel stream data for known material types in order to classify material 104. In some embodiments, the system classifies collected image data only if the collected image data overlaps with known material characteristics over a threshold value or within a threshold range. For example, the system may be configured such that only overlaps of 50% or more of image characteristics are considered to be a confident prediction of classification. In some embodiments, each image parameter of database 112 is associated with a corresponding threshold value that must be met in order for material 104 to be accurately classified. For example, to classify a detected material as oil, the temperature of the material must be within the acceptable range of temperatures for oil.

In some embodiments, a thermal image of detected material, which is determined to be within a certain category, has characteristics that are known to be associated with those types of materials in a known environment. The known environment in this context may relate to a particular weather condition (e.g., a blizzard or a heat wave). For example, database 112 may associate a particular material signature with an environmental condition to account for variations that may be exhibited by the same material. In some embodiments, the system computes a delta of the same thermal image in different environment conditions (e.g., weather, etc.) and normalizes other thermal images of the same material to account for the difference. In some embodiments, accounting for various environmental conditions facilitates the thermal image pattern comparison processes described herein.

In some embodiments, the system computes a size and a location of the detected region of the roadway surface that is affected by material 104, e.g., prior to and/or after determining whether such material is hazardous. This may be referred to as the hazmat spot region. In some embodiments, this computation depends on both the resolution of the camera device or sensor (e.g., sensor 102) and the distance from vehicle 100 to material 104. In some embodiments, the size of the portion of the roadway that is affected by material 104 is determined by Size=Distance*IFoV, where the distance is the distance from vehicle 100 to material 104 at a particular time and the IFoV is the spatial resolution of the camera device or sensor in radians. In some embodiments, the FOV is calculated as the angular size of a single pixel in the camera device's detector array, and is used to compute the IFoV. In some embodiments, the IFOV defines the smallest angle over which the camera can resolve temperature differences. In some embodiments, the IFoV is calculated using the following formula: IFoV=where the FOV is the total angular field of view covered by the camera device and the number of pixels is the one dimension count of pixels in the camera device's array.

In some embodiments, based on classifying material 104 as one of the known substances maintained by database 112, the system determines that material 104 is a hazardous material based on determining that such material poses one or more risks to at least one portion of vehicle 100 and/or to other vehicle(s). In some embodiments, based on comparing the data associated with a captured image depicting the material to the data associated with signatures of known materials maintained by database 112, the system may determine that material 104 is a hazardous material. For example, based on a comparison of data, the system may determine that the detected material is oil, which, if encountered by the tires of a vehicle, poses a risk of the vehicle slipping, and is considered to be hazardous on the surface of a road. In some embodiments, the signatures of known materials in database 112 indicate that a particular material is hazardous when present on the surface of a roadway. In some embodiments, signatures of known materials in database 112 are associated with flags, indicators and/or labels that indicate the related material is hazardous when present on the surface of a roadway. In some embodiments, once material 104 is classified, the system accesses the corresponding material signatures of database 112 to determine that material 104 is hazardous. Additionally or alternatively, one or more machine learning models (e.g., machine learning model 108) may be employed to determine whether a material is a hazardous material. For example, machine learning model 108 may be used to infer the parameters or characteristics of material 104 to be compared to the corresponding attributes, entries or signatures maintained by database 112.

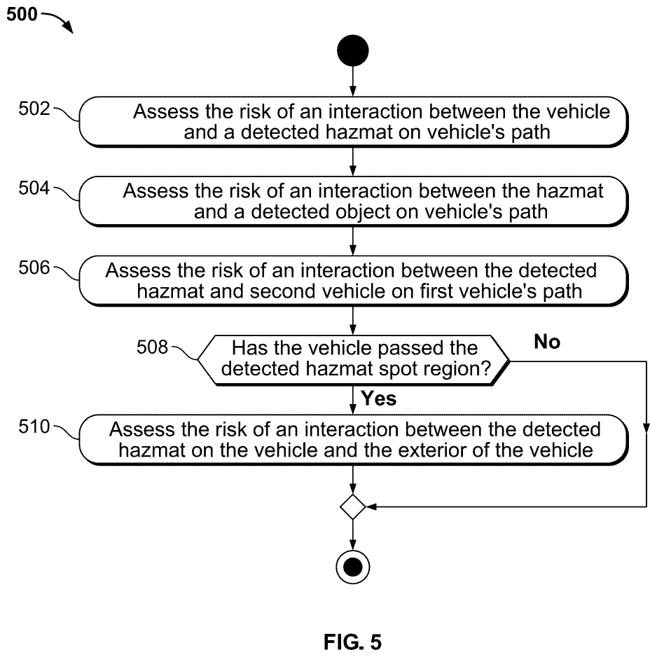

In some embodiments, based on detecting material 104 and calculating its size and location, the system may assess the impact of this detected spot (e.g., the portion of the road surface affected by material 104) for vehicle 100. In some embodiments, the system considers a limited set of possible risk outcomes, such as a slip condition or fire labels. For instance, the presence of oil on the surface of a road creates a slippery surface, significantly reducing tire grip. Such a slippery condition can lead to hydroplaning, where the tires lose contact with the road surface, making it difficult for drivers to control their vehicles. Additional information related to risk assessment is provided in relation to FIG. 5. In some embodiments, associating a particular risk outcome with one or more classification labels leverages one or more external databases, which may have been created based at least in part on crowdsourced historical data, which can be enhanced over time.

In some embodiments, once the data collected from sensor 102 is processed and the assessment of potential risk is performed, the system may provide instructions to vehicle 100 and/or the driver of vehicle 100 for performing an action to ameliorate the detected hazardous material event associated with the detection and classification of material 104, based at least in part on a size, shape, location, and/or other characteristics associated with the hazardous material. For example, if material 104 is determined to be hazardous and vehicle 100 is traveling on a trajectory towards material 104, the system may determine (e.g., based on the risk assessment) that a hazardous material event (e.g., an impact with material 104) is imminent or likely to occur in the near future. In some embodiments, to avoid an encounter with material 104, the system provides instructions to the ADAS system of vehicle 100 or to the perception system of vehicle 100 if it is an AV. In some embodiments, the system suggests a risk avoidance plan for vehicle 100 and/or other vehicles proximate to vehicle 100 or proximate to the identified location of hazardous material 104. For example, vehicles within a threshold distance from vehicle 100 and/or vehicles having a current GPS route that would take them into the area of the hazardous material may be notified of the information related to the hazardous material.

In some embodiments, the instructions to the ADAS system of vehicle 100 comprise alerting the driver of the vehicle of the approaching hazard and/or offering a suggested action (e.g., suggested driving, steering, or braking action) for the driver to take in order to avoid (or reduce the impact of) the encounter with material 104. For example, vehicle 100 may generate for display warning 114, which alerts the driver of the vehicle of the approaching hazard. In some embodiments, warning 114 is presented in distinguishing colors or other visual enhancements designed to draw the eyes of the driver to the alert. In some embodiments, warning 114 is associated with a graphic or image depicting the hazard. In some embodiments, the graphic or image depicting the hazard is overlaid on top of a graphic or image of the surrounding environment of the vehicle. In some embodiments, warning 114 is associated with information related to material 104, such as temperature, distance to the vehicle, size and/or material type. In some embodiments, warning 114 includes any combination of an audio, visual, haptic or textual indication of material 104 or a hazardous material event.

In some embodiments, in addition to or alternative to generating for output an alert to a driver or occupant of vehicle 100, the system generates for display a suggested action for the driver or vehicle to perform to avoid an encounter with material 104. In some embodiments, the suggested action is displayed as suggested action 116, which may utilize the same visual enhancements described in relation to warning 114. For example, if vehicle 100 is not utilizing significant autonomous driving features, suggested action 116 may include a suggestion of at least one of: changing velocity, switching a driving track (lane), changing a steering wheel angle, activating an ABS or suspension system momentarily, adjusting the inter-vehicle distance (e.g., when the object detected close to the area of a hazmat spot is another vehicle), or a position change. In some embodiments, if vehicle 100 is autonomous, the suggested actions are received directly by the autonomous driving system of vehicle 100, and vehicle 100 automatically performs a maneuver (e.g., in accordance with the suggested action) to avoid material 104. In some embodiments, warning 114 and suggested action 116 are presented as a dashboard display of vehicle 100. In some embodiments, warning 114 and suggested action 116 are displayed as a heads-up display (HUD), which may be a transparent or augmented visualization of key driving information that is projected onto one or more portions of the windshield or a separate screen of vehicle 100. In some embodiments, warning 114 and suggested action 116 are additionally or alternatively output at one or more devices (e.g., smartphones) of occupants of the vehicle.

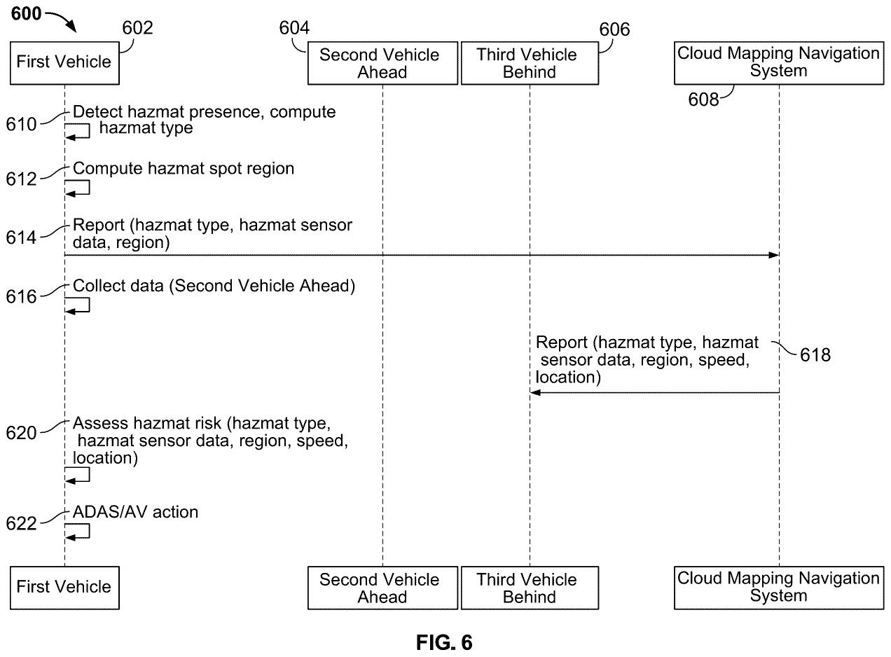

In some embodiments, the instructions provided to vehicle 100 include sending informational data (e.g., related to material 104 and/or the hazardous material event) to one or more mapping/navigation systems that can be received by other vehicles in the vicinity of the detected hazmat spot. In some embodiments, the system uploads the informational data to a cloud network system, and the nature of the risk is computed, e.g., at the cloud. Additional information related to alerting the driver or vehicle to a detected hazard, providing suggested avoidance actions and sharing information with nearby drivers is described in relation to FIGS. 6 and 7.

FIG. 2A is an illustrative graph describing the application of various wavelengths captured by different camera devices, in accordance with some embodiments of the disclosure. In some embodiments, in addition to implementing visible light cameras and sensors (e.g., RGB cameras or sensors and/or hyperspectral cameras, and/or any other suitable types of camera device), IR cameras and sensors are utilized to provide data points across a wider spectrum range. As indicated by the light spectrum chart of FIG. 2A, the sensor of an RGB camera device typically collects data between the red and violet wavelengths (e.g., between about 450 and 740 nm or 380 to 700 nm). IR camera devices and sensors may be designed to capture data across, e.g., between about 780 nm and 1 mm). In particular, by using IR rays, images of objects may be captured in a dark environment and at night.

In some embodiments, the system employs, at least in part, an IR camera or sensor (and/or hyperspectral cameras, and/or any other suitable types of cameras) to detect objects on the surface of a driving path of a vehicle. In some embodiments, sensor 102 of FIG. 1 utilizes an IR camera device or sensor to detect material 104. In some embodiments, an IR camera or sensor is used in combination with one or more other camera devices or sensors to detect objects on the surface of a driving path. For example, all objects above absolute zero temperature naturally emit IR light corresponding to the temperature of the object. In some embodiments, an IR camera or sensor captures the intensity of the light emitting from an object and displays it as an image of heat distribution (e.g., as indicated by image elements 214, which depict the bright white portions of image 212 of FIG. 2B).

In some embodiments, to help accurately detect and classify objects on road surfaces (e.g., as described in relation to FIG. 1), the IR camera and/or hyperspectral camera may be used to determine spectral ranges for material 104, based at least in part on measuring temperature ranges. For example, relatively higher temperatures emit relatively shorter wavelength IR radiation and relatively lower temperatures emit relatively longer wavelength IR radiation. In some embodiments, a near-infrared (NIR) or short-wave infrared (SWIR) camera device is used to detect objects at high temperatures (e.g., about 450° C. to 2450° C.). For example, NIR-SWIR cameras are designed to capture data at range 202 (e.g., about 780 nm to 1.4 μm) and range 204 (e.g., about 1.4 μm to 3 μm) of the wavelength spectrum. In some embodiments, a mid-wave infrared (MWIR) (e.g., also referred to as thermal IR) camera device is used to detect objects at low and intermediate temperatures with high precision. For example, MWIR cameras are designed to capture data at range 206 (e.g., about 3 μm to 5 μm) of the wavelength spectrum chart. In some embodiments, a long-wave infrared (LWIR) camera (e.g., also referred to as a far infrared (FIR) camera) is used to detect objects at “low” temperature measurements (e.g., between −50° C. and 900° C.). For example, LWIR cameras are designed to capture data at range 208 (e.g., about 8 μm to 14 μm) of the wavelength spectrum chart. Detecting each part of the IR spectrum is useful for a variety of purposes based on how different objects emit, reflect, or absorb IR light.

In some embodiments, implementing one or more LWIR cameras or sensors is sufficient for detecting the majority of common surface materials (hazardous or non-hazardous). In some embodiments, in a non-limiting example, the LWIR camera device preferably operates with a thermal sensitivity of about 40 mK and a resolution of 640×480 pixels. In some embodiments, the FOV of the LWIR camera is determined by the thermal camera lens of the camera and refers to the extent of the scene that the LWIR camera can capture. For example, the greater the FOV, the greater the area or space of a vehicle's surrounding environment that can be captured with the LWIR camera. In some embodiments, the FOV of the LWIR camera is at least equal to and overlaps with the FOV of an RGB camera that is used simultaneously with the LWIR camera. In some embodiments, the FOV of the LWIR camera is smaller than the FOV of the RGB camera, allowing the LWIR to capture image data from a more precise portion of the surrounding environment. In some embodiments, implementing a combination of camera devices (e.g., LWIR and RGB cameras) provides a broad range of coverage for detecting most objects in the path of a vehicle (e.g., including in low visibility driving scenarios).

In some embodiments, as a vehicle (e.g., vehicle 100 of FIG. 1) moves forward along a roadway, image data is collected from visible-light cameras or night-vision cameras (e.g., if dark or heavy fog, rain, etc.), as well as from one or more LWIR cameras. In some embodiments, the image data includes an image of the area in front of a vehicle (or at a side or rear of the vehicle, or any other suitable direction with respect to the vehicle). In some embodiments, the object-detecting image sensor or camera device is configured to detect an object or an area in front of the vehicle. In some embodiments, the object detected by the image sensors or camera devices is another vehicle ahead or detected hazmat region. In some embodiments, implementing a combination of RGB and LWIR camera devices is accomplished by using one or more regular, un-cooled LWIR cameras that operate at 25 Hz to 60 Hz.

In some embodiments, the LWIR camera or sensor is configured to focus on the radiation emitted from the objects present on the surfaces of roads or other driving paths. In some embodiments, the data collected from the LWIR camera or sensor has thermal data. In some embodiments, the one or more LWIR cameras or sensors utilize one or more types of microbolometers (or other thermal sensors), which convert thermal energy into electrical signals (e.g., without requiring cooling or thermographic sensors) that may measure or be indicative of temperature differences in an image based on emitted IR radiation of respective portions of the image. For example, the system may determine whether material 104 is a hazardous material based at least in part on the temperature of material 104, and/or other characteristics of material 104, gleaned from IR images of the material 104. In some embodiments, crowdsourced data may be analyzed to determine a rate of change of temperature, or a rate of change of another characteristic of material 104, which may be indicative of whether the material is a hazardous material, e.g., a potentially hazardous material such as oil may not be capable of changing in temperature at the same rate that is detected, while potentially non-hazardous water may be capable of a change in the temperature at the detected rate. In some embodiments, the settings of a particular camera device or sensor may be adjusted based on one or more environmental conditions. In some embodiments, the camera device or sensor is configured to automatically switch modes when a particular environmental condition is detected. For example, when it is detected that the temperature of a road is under a threshold temperature, the camera device may transition into a mode that allows for more accurate detection of black ice.

In some embodiments, to ensure accurate image capturing and data processing, the frame rate of the LWIR camera is configured to be consistent with the framerate of the RGB camera (e.g., usually 30 frames per second), as various image data is collected over different wavelength spectrums.

In some embodiments, one or more hyperspectral imaging cameras or sensors are used alternatively to or in combination with LWIR cameras. For example, a hyperspectral imaging camera may be used to capture a broader spectrum of wavelengths and allows for detailed analysis of materials based on their unique spectral signatures. In some embodiments, measurements from hyperspectral imaging cameras or sensors may be correlated to the output of RGB cameras used in the same system. In some embodiments, the hyperspectral imaging camera may be used to capture IR imagery and/or any other suitable types of imagery.

In some embodiments, a time-of-flight (ToF) method is performed to determine the distance of the detected objects (e.g., material 104) from vehicle 100 of FIG. 1. For example, a ToF method is a depth-sensing technique used to measure the distance of objects in an image by calculating the time it takes for light to travel to the object and back to the sensor. In some embodiments, one or more multi-mode cameras are used to perform wideband measurement of the visible light, NIR (e.g., range 202) and FIR (e.g., range 208) spectrums on a common optical axis by performing a multi-wavelength synthesis. In some embodiments, if one or more multi-mode cameras are not used, synchronization of the frame rates corresponding to various separate cameras is performed to help provide consistency among the image data.

FIG. 2B is an illustrative example of images captured using different camera devices, in accordance with some embodiments of the disclosure. Because IR radiation emitting from objects is not visible to the human eye, color palettes are convenient ways for humans to visualize and understand a thermal image. In some embodiments, the IR camera device or sensor used to detect objects on the surface of a roadway comprises a sensor with thousands of pixels (or any other suitable number of pixels). In some embodiments, each pixel of the IR sensor captures the radiation emitted from respective portions of an image, and the levels of emitted radiation are individually expressed in a final image. In some embodiments, the final image depicts the full temperature of every pixel of the image. In some embodiments, the final image depicts an average temperature across the entire image. The system may identify the region corresponding to material 104 based at least in part on temperature differences from other regions of the image, and/or based on a comparison and normalization of coordinates of material 104 ascertained based on analysis of visible light imagery to the IR image. For example, and as described in relation to FIG. 2A, while traveling in a dark environment, a night-vision camera may capture a clear image of an object in the dark, allowing the object to be detected (e.g., as shown by image 210), and an LWIR camera may capture the thermal data of the detected object, allowing the object to be classified (e.g., as shown by image 212).

In some embodiments, a color map or color palette is configured and specifically tailored to generate a visual representation of the different wavelength emissions captured by an IR camera or sensor. For example, and as shown by image 212, the color blue (e.g., or darker regions) indicates colder temperatures, medium yellow (e.g., indicates warmer regions), and red hot (e.g., indicates brightest regions). As a further example, in most thermal images, red- and bright white-colored pixels symbolize the hottest parts of the image (e.g., as indicated by image elements 214), while green-, blue-, and purple-colored pixels symbolize cooler temperatures. In some embodiments, the LWIR cameras produce a single-channel output (e.g., each pixel is represented by one intensity value that corresponds to the thermal energy emitted from the objects in the captured area). In some embodiments, eight bits of data per pixel are collected from the LWIR camera or sensor, which allows for 256 intensity levels to be captured in a single image. In some embodiments, to detect certain uncommon materials, 12 bits of data per pixel are collected from the LWIR camera or sensor to provide 4,096 levels of intensity. For example, the more granular data can be used to capture finer details in temperature variation. In some embodiments, the pixel data is organized in a linear format, where each pixel's intensity value is stored sequentially, such as Y₁ . . . . Y_{N}, and where Y_{N} represents the intensity value of the N^{th} pixel. In some embodiments, the measured pixel values are tagged based on the wavelength associated with the ToF distance value in order to determine the spatial information related to a hazardous material event.

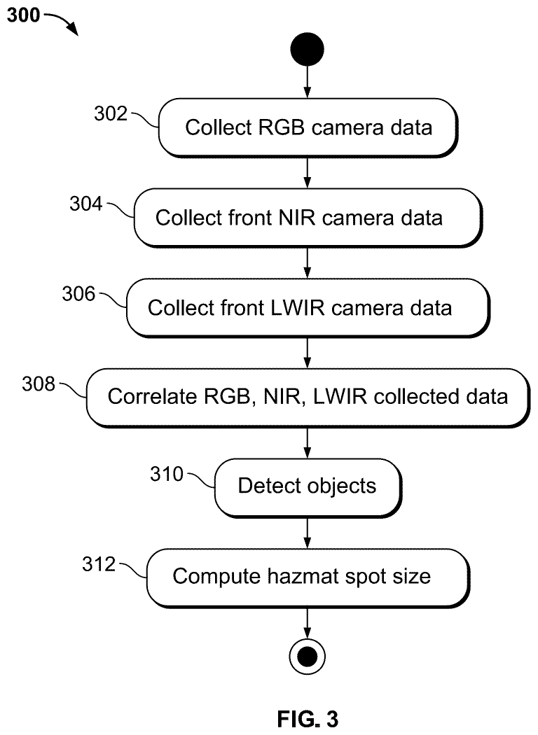

FIG. 3 is a flowchart of the process for detecting hazardous material and computing a size of the hazard, in accordance with some embodiments of the disclosure. In various embodiments, the individual steps of process 300 may be implemented by one or more components of the devices, techniques and software described herein. Although the present disclosure may describe certain steps of process 300 (and of other processes described herein) as being implemented by certain components of the devices and software described herein, this is for purposes of illustration only, and it should be understood that other components of the devices and systems described herein may implement those steps instead.

Process 300 begins at step 302, where control circuitry (e.g., control circuitry 804 or 911 of FIGS. 8 and 9, respectively) is configured to utilize a combination of camera devices and sensors to capture an image of an object in the path of a vehicle (e.g., vehicle 100 of FIG. 1). For example, the vehicle may be equipped with one or more RGB cameras and one or more IR cameras configured to capture image data at various wavelengths (e.g., NIR and LWIR cameras). In some embodiments, at step 302, the control circuitry is configured to collect the image data captured by one or more RGB cameras. At step 304, the control circuitry is configured to collect the image data captured by one or more NIR cameras. At step 306, the control circuitry is configured to collect the image data captured by one or more LWIR cameras. In some embodiments, the various camera devices of the system are configured to capture images of a vehicle's surroundings and the control circuitry is configured collect data from those images in any manner as described in relation to FIGS. 1-2B.

In some embodiments, at step 308, the control circuitry is configured to correlate the image data collected from the camera and sensor components of the system (e.g., RGB, NIR and LWIR camera data). In some embodiments, and as described in relation to FIGS. 2A-2B, accurate processing of image data from various camera devices involves synchronizing the frame rate associated with all of the camera devices being implemented. In some embodiments, correlating the collected image data includes outputting the data in the form of a visual image or graph in any manner as previously described. At step 310, based on analyzing the correlated set of image data, an object is detected in the path of the vehicle. In some embodiments, the detected object is material 104 of FIG. 1. In some embodiments, process 300 ends at step 312, where the control circuitry proceeds to compute the size and location of the object in the path of the vehicle. In some embodiments, the control circuitry performs this computation after it determines that the detected object poses a hazard risk to the driver or vehicle. In some embodiments, the control circuitry performs this computation immediately after the object is detected and prior to classifying the object. For example, if the detected object is a shallow puddle of water on a hot summer day, the risk to the driver or vehicle may be minimal, but traveling through the object is not ideal.

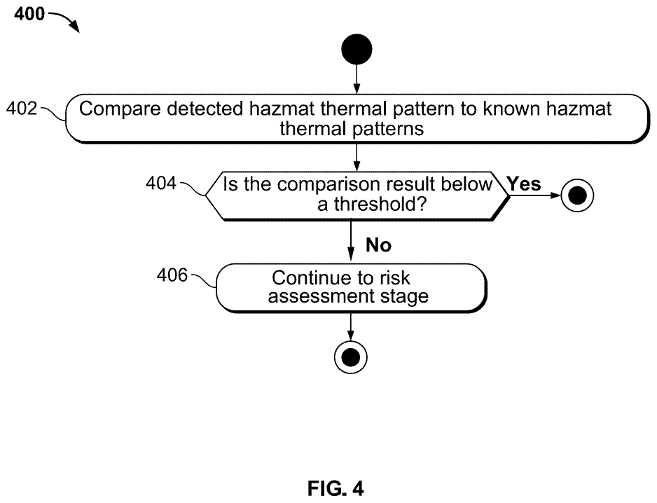

FIG. 4 is a flowchart of a process for determining whether to perform a risk assessment for a detected hazard based on known hazard patterns, in accordance with some embodiments of the disclosure. In various embodiments, the individual steps of process 400 may be implemented by one or more components of the devices, techniques and software described herein. Although the present disclosure may describe certain steps of process 400 (and of other processes described herein) as being implemented by certain components of the devices and software described herein, this is for purposes of illustration only, and it should be understood that other components of the devices and systems described herein may implement those steps instead.

Process 400 begins at step 402, where control circuitry (e.g., control circuitry 804 or 911 of FIGS. 8 and 9, respectively) is configured to compare thermal data associated with an image captured of a vehicle's surrounding environment to thermal data associated with known materials. For example, the control circuitry may receive data from one or more camera devices indicating that an object (e.g., material 104 of FIG. 1) is on the surface of a roadway. In some embodiments, the control circuitry is configured to use one or more camera devices of a vehicle (e.g., vehicle 100 of FIG. 1) to capture an image, and the data associated with the image contains thermal data. In some embodiments, images are captured, and the corresponding image data is processed in any manner as previously described.

In some embodiments, at step 402, the control circuitry detects an object and attempts to classify the detected object. In some embodiments, the object is detected in any manner as previously described (e.g., by using one or more camera devices). In some embodiments, the control circuitry attempts to classify the detected object by comparing the data associated with an image of the detected object to data stored in a database (e.g., database 112 of FIG. 1). For example, various object characteristics of the captured image (e.g., wavelength, temperature, viscosity, etc.) may be analyzed and compared to similar parameters maintained in a database of known objects, as described in relation to FIG. 1.

In some embodiments, at step 404, the control circuitry determines whether the detected object is one of the known objects in the database based on whether a correspondence between characteristics of the detected object and characteristics of the respective objects in the database meets or exceeds a threshold correspondence value. For example, if the correspondence between sets of characteristics is less than a threshold (e.g., 50% or more), the control circuitry may be unable to confidently classify or categorize the detected object. In some embodiments, if the correspondence between sets of characteristics is less than the threshold correspondence value, the control circuitry refrains from proceeding to assessing the potential risk posed by the detected object, and process 400 ends. Alternatively, if the correspondence between sets of characteristics meets or exceeds the threshold correspondence value, the control circuitry accurately determines that the detected object is a known object type in the database, and process 400 proceeds to step 406. At step 406, the control circuitry begins to assess the potential risk posed by the identified object, which is further described in relation to FIG. 5.

FIG. 5 is a flowchart of the process for performing an assessment of potential risk to a vehicle based on a detected hazard, in accordance with some embodiments of the disclosure. In various embodiments, the individual steps of process 500 may be implemented by one or more components of the devices, techniques and software described herein. Although the present disclosure may describe certain steps of process 500 (and of other processes described herein) as being implemented by certain components of the devices and software described herein, this is for purposes of illustration only, and it should be understood that other components of the devices and systems described herein may implement those steps instead.

Process 500 begins at step 502, where control circuitry (e.g., control circuitry 804 or 911 of FIGS. 8 and 9, respectively) is configured to assess the risk resulting from a potential encounter between the vehicle (e.g., vehicle 100 of FIG. 1) and a detected hazard (e.g., material 104 of FIG. 1) in the path of the vehicle. For example, control circuitry of the vehicle may have analyzed images of the vehicle's surroundings to determine that there is a known hazard in the roadway, and that a hazardous material event is imminent. At step 502, the control circuitry computes the risk to one or more parts of the vehicle, or an occupant of the vehicle, based on a predicted interaction between the vehicle and the hazardous material (e.g., driving over a portion of the hazardous material). In some embodiments, the control circuitry computes potential risk in any manner as previously described (e.g., by using crowdsourced historical data).

In some embodiments, assessing the potential risk posed by a road hazard includes considering a variety of parameters, such as hazard spot size, distance from vehicle, vehicle speed, current temperature of the hazard, environmental temperature, and road conditions (e.g., gradient, dry, wet, snow-covered, etc.). For example, the control circuitry may compute the risk of slipping by including the friction coefficient (μ) between tires and a road surface and the stopping distance of the vehicle. As a further example, the coefficient of friction for tires on an oiled surface is typically much lower than tires on dry asphalt (e.g., μ≈0.1-0.3 for oiled surfaces versus μ≈0.7-0.9 for dry surfaces). In some embodiments, the stopping distance of a vehicle is calculated by

$$D = \frac{{V}^{2}}{2 g μ} ,$$

where D is the stopping distance, V is the initial velocity (in m/s) and g is the acceleration due to gravity (about 9.8 m/s²). In some embodiments, a computed stopping distance for a vehicle may be considered when suggesting any AV/ADAS actions to avoid the hazardous material.

In some embodiments, at step 502, the hydroplaning speed can be calculated by Vₕₚ=9\sqrt{t}, where Vₕₚ is the hydroplaning speed and t is the tire tread depth in millimeters. For example, based on the hydroplaning speed calculation, the control circuitry may determine that the current speed of the vehicle is higher than the hydroplaning speed and the vehicle's stopping distance is greatly increased. In response, the control circuitry may determine that this is a potentially dangerous situation that the vehicle should avoid. In some embodiments, tire tread readings can be obtained from sensors that offer automated and continuous tread depth measurements, particularly for commercial fleet vehicles. In some embodiments, tire tread sensors utilize AI algorithms to provide daily updates on tire wear rates, which enhances service planning and operational efficiency.

In some embodiments, in addition or alternative to computing a risk of slipping, the control circuitry computes a potential fire risk. For example, a detected spill on a roadway may be classified as spilled fuel based on readings from an LWIR camera. Based on that information, the control circuitry may measure the vehicle's speed and estimate, when the vehicle passes the spill area, what the external tire temperature may be and whether there is a possible fire hazard resulting from a spark caused by the vehicle passing over the fuel at a high speed. As a further example, tires typically operate at temperatures between 100° F. to 150° F. (37° C. to 65° C.) during normal driving conditions. However, under extreme conditions, such as improper inflation or excessive friction (e.g., caused by hot road surfaces), tire temperatures can rise significantly. As another example, when tire temperatures are between 200° F. to 300° F. (93° C. to 149° C.), tires can begin to affect adjacent vehicle components, but they are not yet at ignition levels. Flammable vapors begin to form at about 500° F. to 550° F. (260° C. to 288° C.). In some cases, tires may ignite spontaneously at temperatures between 800° F. to 900° F. (427° C. to 482° C.). It is common for tires to experience a temperature increase of about 50° F. (10° C.) after running for approximately half an hour at highway speeds. In some embodiments, at ambient temperatures, temperatures of vehicle tires (e.g., for vehicles with heavy loads or under-inflated tires) can rise above 200° F. (93° C.). In some embodiments, the vehicle utilizes a battery-driven pressure sensor, which transfers pressure information to a central control unit that reports the information to the vehicle's onboard computer. In some embodiments, a tire sensing unit also measures and alerts the driver to temperatures of the tire. In some embodiments, the control circuitry analyzes the data received from various tire-related sensors to determine if a fire hazard exists.

In some embodiments, at step 504, the control circuitry uses similar techniques (e.g., the processes described in relation to step 502) to assess the risk resulting from a potential encounter between another object and a detected hazard. In some embodiments, when determining potential risk, the control circuitry may consider other objects that are close to the area affected by the hazardous condition. For example, objects such as small rocks and gravel have the potential to create a spark when encountering a fuel spill (e.g., due to friction), which may lead to a fire.

In some embodiments, at step 506, the control circuitry uses similar techniques (e.g., the processes described in relation to step 502) to assess the risk resulting from a potential encounter between a second vehicle and a detected hazardous material. For example, the control circuitry may use risk analysis algorithms that compute the possibility of a second (e.g., another) vehicle, ahead of a first vehicle path, encountering the hazardous condition (e.g., such as slipping in oil spill). The control circuitry may use this information to compute any additional risk to the first vehicle resulting from a potential slip/slide experienced by the second vehicle.

In some embodiments, at step 508, the control circuitry determines whether the vehicle has passed the detected hazard. For example, the control circuitry may compare the GPS coordinates and moving direction of the vehicle to the known location of the hazard in order to determine if the vehicle has passed it or not. In some embodiments, if the vehicle has not yet passed the hazardous condition, the control circuitry may present a warning or driving suggestion (e.g., as described in relation to FIGS. 1 and 6) to the driver and/or vehicle (e.g., based on the assessment of risk), and process 500 ends. Alternatively, if the vehicle has passed the hazardous condition, process 500 proceeds to step 510, where the control circuitry performs an analysis of risk based on any potential interaction between the hazardous material and one or more parts of the exterior of the vehicle.

In some embodiments, the vehicle experiences a direct encounter with the hazard. For example, a vehicle may not be able to navigate away from the hazardous material due to heavy traffic or traveling at high speeds. In some embodiments, the system performs another analysis of risk to the vehicle based on the additional data obtained by the direct encounter with the hazard. In some embodiments, aspects of the additional analysis are shared with other nearby vehicles. In some embodiments, if it was previously determined that running over the hazmat material may not cause enough risk for concern, the control circuitry performs the further analysis to determine if, for example, fuel has made contact with the tires of the vehicle. If such contact occurs, there is still fire risk because a moving vehicle is made of many components with high heat surfaces, such as the vehicle's undercarriage, exhaust system, brake rotors, pads, calipers or other external mechanical parts, which may cause sparks capable of igniting the fuel-coated tires. In some embodiments, the additional analysis is specific to the vehicle since the analysis is performed after the vehicle passes the detected hazmat area. In some embodiments, the further analysis is specific to the detected material, and compares measurements before and after the encounter with the material. For example, spilled oil may spread and its temperature may increase as a result of a tire passing through the material at a high speed. In some embodiments, any further risks determined from the additional analysis are immediately reported to the driver of the vehicle or to an ADAS/AV system, which may take action to remediate/avoid the hazardous situation (e.g., as further described in relation to FIG. 6).

In some embodiments, if the vehicle experiences an encounter with the hazardous material, the system leverages onboard sensors and advanced data processing techniques to accurately compute the hydrodynamic parameters of the spilled fluid. In some embodiments, this approach prepares the vehicle's sensors to collect real-time dynamic data during the encounter. For example, this approach may enable the full capacity and the highest precision of the onboard sensors or direct the angle of the sensors towards the hazards, thus enabling a precise analysis of the fluid's viscosity and flow characteristics, which surpasses the estimations made without these preparations.

In some embodiments, the system implements one or more wheel speed sensors and/or traction control systems to detect variations in wheel rotation and slip ratios as the vehicle passes over material. For example, by monitoring discrepancies between expected and actual wheel speeds, the system can infer reductions in traction that correlate with a particular fluid's viscosity. In some embodiments, accelerometers and gyroscopes are used to capture changes in acceleration, deceleration, and lateral movements, thus providing insights into how the material affects vehicle dynamics. In some embodiments, the system also analyzes torque inputs and wheel behavior to calculate the coefficient of friction in real time, providing further information about the material's lubricating properties. In some embodiments, one or more underbody- and/or tire-mounted sensors are configured to detect direct contact with liquid material, measuring its presence and thickness. In some embodiments, the system employs one or more acoustic sensors to detect changes in sound and/or vibration patterns resulting from the interaction between the vehicle's tires and the spilled material.

In some embodiments, all collected data (e.g., the data collected from the various sensors and camera devices associated with a vehicle) is processed through advanced algorithms to detect objects, assess risk to the vehicle or occupants and/or determine an action in response to the hazard. In some embodiments, these algorithms incorporate machine learning models trained on controlled datasets of various materials and road conditions. In some embodiments, these algorithms calculate key hydrodynamic parameters, such as viscosity, by applying principles of fluid mechanics, including shear stress and shear rate calculations. In some embodiments, these algorithms are used to compute the Reynolds number of liquid material, which describes the flow characteristics of the material (e.g., whether the fluid's behavior is laminar or turbulent) and impacts how the spilled material may spread over a road surface.

In some embodiments, by preparing the various camera devices and sensors of the vehicle, and combining the data collected from these diverse sources, the system attains a comprehensive and precise understanding of the material's properties during the encounter with the vehicle. In some embodiments, the system shares this refined and valuable information with other vehicles (e.g., as described in relation to FIGS. 1 and 6-7).

While the examples of FIG. 5 (and other examples provided herein) describe the assessment of a slipping and/or fire risk to a vehicle, it should be appreciated that the control circuitry of a vehicle is capable of assessing the risk of any number of suitable conditions with the potential to harm one or more parts of the vehicle (e.g., crashing, explosion, rollover, etc.). Additionally, the examples provided herein are not limited to only flammable fuels, gases and vapors, and may be applied to any number of hazardous materials that may be found on the surface of a roadway. Furthermore, while the example risk assessment calculations consider factors such as vehicle speed and coefficient of friction, it should be appreciated that the risk assessment calculations may include other suitable environmental parameters (e.g., moisture in the air, temperature, etc.) that may have an impact on the occurrence of a hazardous material event.

FIG. 6 is a sequence diagram illustrating the process of performing a vehicle action in response to detecting a hazard, in accordance with some embodiments of the disclosure. For example, process 600 begins at step 610, where first vehicle 602, second vehicle 604 (e.g., ahead of first vehicle 602) and third vehicle 606 (e.g., behind first vehicle 602) are traveling on a roadway, and all vehicles are connected to each other via cloud navigation system 608. In some embodiments, first vehicle 602 is vehicle 100 of FIG. 1. In some embodiments, first vehicle 602 detects the presence of hazardous material on the surface of the roadway, which may be located in the path ahead of second vehicle 604, which is traveling in front of first vehicle 602. In some embodiments, first vehicle 602 detects the material on the road surface in any manner as previously described in relation to FIGS. 1-2B.

In some embodiments, at step 612, first vehicle 602 computes the size and location of the hazardous material on the roadway. In some embodiments, first vehicle 602 computes the size and the location of the material as described in relation to FIG. 1 (e.g., based on the spatial resolution of the camera device and the distance between the vehicle and the material). In some embodiments, at step 614, first vehicle 602 reports the information related to the hazardous situation to cloud navigation system 608. For example, first vehicle 602 may have classified the detected material as a hazardous material capable of harming one or more of the vehicles traveling on the roadway, and transmitted the related information to cloud navigation system 608. In some embodiments, the information related to the detected material is transmitted to cloud navigation system 608 before an assessment of risk relating to vehicle 602 is performed. In some embodiments, cloud navigation system 608 is a mapping/navigation system such as Google Maps or is run by an AV/Ridesharing fleet.

In some embodiments, the information transmitted to cloud navigation system 608 comprises metadata related to a detected hazmat region, such as the GPS location, detected material type, size, shape and thermal data, time information, weather information (e.g., temperature and precipitation) and camera/sensor data, among other suitable data. In some embodiments, the shared metadata is queried and transmitted (e.g., at step 618) to other nearby vehicles (e.g., third vehicle 606) who query/subscribe to the information or navigation service. In some embodiments, the transmitted metadata is automatically broadcasted to all vehicles with a current route on track to pass the location of the detected hazard region. In some embodiments, when other nearby vehicles (e.g., third vehicle 606) receive the hazmat metadata from a navigation service (e.g., cloud navigation system 608), the receiving vehicles' ADAS/AV perception systems can perform their own calculations (e.g., along with their own hazmat detection process) to make decisions with the objective of avoiding the hazardous situation. In some embodiments, the other vehicles receive a notification associated with the hazard region.

In some embodiments, third vehicle 606 is not subscribed to cloud navigation system 608 or is incapable of accessing it (e.g., older vehicles may not have the equipment or technology to access cloud navigation networks). In some embodiments, cloud navigation system 608 indicates which nearby vehicles are a part of or subscribed to the navigation network. In some embodiments, if third vehicle 606 cannot interact with cloud navigation system 608, the full dataset of information related to a detected hazard cannot be received by third vehicle 606. In some embodiments, if third vehicle 606 does not engage with cloud navigation system 608, first vehicle 602 transmits a subset of the applicable dataset of information (e.g., vehicle make, vehicle model, velocity, weather condition, recorded RGB video if applicable, etc.) to an accident metadata server. In some embodiments, the subset of data provided to the accident metadata server additionally includes the measured hazmat thermal spectral vector data and its associated spot region. In some embodiments, the detected and/or avoided hazmat metadata of a first vehicle 602 is collected and transmitted to an insurance carrier associated with first vehicle 602 or its driver. For example, the hazmat metadata may be beneficial in the UBI (usage based insurance) computation for a hazmat insurance policy.

In some embodiments, at step 616, first vehicle 602 collects data related to second vehicle 604, which is ahead of first vehicle 602 and closer to the hazard region. In some embodiments, and as described in relation to FIG. 5, the vehicle considers the information related to other vehicles to determine whether the other vehicles may encounter the hazardous material. In some embodiments, this information is used to determine how other vehicles encountering the material may impact the assessment of risk for the first vehicle (e.g., other vehicles slipping on the material and crashing into the first vehicle).

In some embodiments, at step 620, first vehicle 602 performs an assessment of risk for the first vehicle based on the information related to the detected hazmat region. In some embodiments, first vehicle 602 assesses risk in any manner as described in relation to FIGS. 1 and 5. In some embodiments, the assessment of risk additionally includes considering the probability and impact of other vehicles (e.g., second vehicle 604), near first vehicle 602, encountering the detected material.

In some embodiments, at step 622, first vehicle 602 provides a suggested avoidance action to the ADAS/AV system of the vehicle to avoid an encounter with the hazard region. For example, and as described in relation to FIG. 1, the suggested ADAS/AV action may be an alert that the vehicle is approaching a hazard region and/or a suggested driving maneuver (e.g., velocity or lane change). In some embodiments, the metadata related to the detected hazmat spot is enhanced if a suggested action is not taken by a driver or AV, and the foreseen risk materializes. For example, if a driver disregards a suggested avoidance action and an accident occurs (e.g., fire, spin, crash, explosion, rollover, etc.), measurements of the vehicle's parameters (e.g., velocity) and other sensor data (e.g., component temperature, tire tread, road condition, gimbal readings, position estimator, etc.) are updated and provided to the shared navigation service, which can be transmitting to other nearby vehicles for use during risk assessment. In some embodiments, the metadata related to the detected hazmat spot is provided to one or more servers associated with an insurance company or vehicle tracking device (e.g., for accident assessment and/or other automobile insurance procedures). In some embodiments, this crowdsourced historical data is maintained by a navigation server or database and is utilized for hazmat risk analysis by other vehicles in the future.

FIG. 7 is an illustrative example of vehicle components used to detect a hazardous material event and perform an action to ameliorate the event, in accordance with some embodiments of the disclosure. In some embodiments, systems and components of a motor vehicle, such as vehicle 700, implement the embodiments described herein. In some embodiments, the various components of vehicle 700 described herein are used to detect objects on the surface of a road in the path of vehicle 700, as well as other hazards (e.g., dangerous air conditions or chemical vapors/gases). In some embodiments, vehicle 700 is vehicle 100 of FIG. 1 or first vehicle 602 of FIG. 6. In some embodiments, vehicle 700 utilizes one or more camera devices or sensors, such as thermal camera 702, to capture image or video data of the vehicle's surrounding environment. In some embodiments, thermal camera 702 is sensor 102 of FIG. 1. For example, thermal camera 702 may be one or more camera devices capable of capturing the thermal properties of objects in images.

In some embodiments, thermal camera 702 is one or more IR cameras, such as LWIR cameras. In some embodiments, vehicle 700 utilizes multiple LWIR cameras positioned at exterior points of the vehicle to increase the accuracy of the camera data. In some embodiments, the system generates a comprehensive view of the vehicle's surrounding environment using a series or combination of camera devices (e.g., by using image stitching techniques). For example, thermal images of one or more IR cameras may be stitched together to construct a panorama of the environment if multiple hazmat areas are detected, but are not contiguous with each other on the road surface. In some embodiments, thermal camera 702 has a varying FOV, ranging from wide-angle (e.g., up to 120 degrees), for close-range detection, to narrow-angle for long-range visibility. In some embodiments, to account for decreasing angles of thermal camera 702 (e.g., when the system detects visibility to be narrow or when vehicle 700 approaches a curve or a slope), the camera system shifts its focus to maintain accurate perception of the road geometry.

In some embodiments, to adapt to changes in perspective caused by the movements of vehicle 700 (e.g., turns or inclines, etc.), the ADAS/AV system of vehicle 700 (e.g., which controls thermal camera 702) can simulate different positions on a roadway by shifting captured images horizontally and vertically. For example, the systems of vehicle 700 can augment the sensor data of thermal camera 702 using techniques that include rotating images slightly during data augmentation. Such techniques are used to train the object detection model to become agnostic to camera orientation or angle, thereby improving the model's ability to recognize road features regardless of angle.

In some embodiments, a You Only Look Once (YOLO) object detection model (or any suitable modification thereof, or any other suitable machine learning model(s)) is used as a more energy-efficient alternative. In some embodiments, the YOLO model is used, in real time, to process an image in a single pass in order to detect and classify objects simultaneously. For example, the YOLO model may be a one-stage detector that performs bounding box coordination and classification, at a particular period of time, through the same neural network structure.

In some embodiments, thermal camera 702 is positioned underneath vehicle 700 to identify hazmat materials on the surface of the road. For example, while this particular positioning of thermal camera 702 may not assist vehicle 700 in leveraging the collected data, any potentially risky conditions captured by thermal camera 702 can be reported to a cloud mapping navigation system (e.g., cloud navigation system 608 of FIG. 6) that can share such data with other vehicles that are scheduled to pass the hazmat spot region.

In some embodiments, vehicle 700 utilizes one or more light detection and ranging (LiDAR) cameras, such as LiDAR camera 704. In some embodiments, LiDAR cameras create a 3D map of a vehicle's surroundings by emitting laser pulses and measuring their reflection times. In some embodiments, LiDAR camera 704 is a part of vehicle 700's ADAS/AV system and helps the vehicle measure distances and navigate safely. In some embodiments, LiDAR camera 704 is used alone or in combination with other camera devices or sensors (e.g., thermal camera 702) to detect objects on the surface of a roadway, calculate risk and perform an action in response.

In some embodiments, vehicle 700 implements one or more video cameras, such as video camera 706. In some embodiments, video camera 706 enables the real-time recognition of pedestrians, vehicles, road signs, obstacles and objects in a road. In some embodiments, the systems of vehicle 700 analyze each frame of video captured by video camera 706 to detect objects. In some embodiments, the data collected from video camera 706 is used in combination with other camera data (e.g., data from thermal camera 702 and/or LiDAR camera 704) to detect objects, calculate risk and perform an action in response.

In some embodiments, vehicle 700 is equipped with one or more position estimators, such as position estimator 708. In some embodiments, position estimator 708 is used to determine a vehicle's exact location, orientation, and movement in real time. In some embodiments, data collected from a vehicle's position estimator is used to assess potential risk to one or more parts of a vehicle (e.g., based on the vehicle's position) and to suggest an action for the vehicle to perform in response to a hazardous situation.

In some embodiments, vehicle 700 uses one or more radar devices, such as radar device 710. In some embodiments, radar device 710 is used to detect objects, measure distances, and track speed by sending out radio waves and analyzing their reflections. In some embodiments, data collected from radar device 710 is used (e.g., alone or in combination with other camera/sensor devices) to detect objects on a roadway, calculate risk and perform an action in response.

In some embodiments, vehicle 700 implements vehicle-to-vehicle (V2V) cooperative sensing features to efficiently communicate with other nearby vehicles, such as V2V system 714. For example, as shown by image 712, a vehicle that has detected a road hazard may share information related to the hazard with additional vehicles using a V2V system. In some embodiments, V2V system 714 is an advanced communication system where nearby vehicles share real-time sensor data with each other to enhance safety, improve situational awareness, and support autonomous driving. In some embodiments, V2V system 714 is a part of vehicle 700's vehicle-to-everything (V2X) system (not shown) and plays a crucial role in the ADAS and self-driving systems of the vehicle. In some embodiments, V2V system 714 is used in combination with or alternative to a cloud navigation service (e.g., cloud navigation system 608 of FIG. 6) to communicate hazard region information to other nearby vehicles.

In some embodiments, vehicle 700 is equipped with one or more ultrasonic sensors, such as ultrasonic sensor 716. In some embodiments, ultrasonic sensor 716 detects nearby objects by emitting high-frequency sound waves and measuring their reflections. In some embodiments, ultrasonic sensor 716 is used to detect closer objects at lower speeds. In some embodiments, data collected from ultrasonic sensor 716 is used to detect objects on a roadway or in the path of vehicle 700, calculate risk and perform an action in response.

In some embodiments, vehicle 700 utilizes one or more global positioning system (GPS) units, such as GPS 718. In some embodiments, GPS 718 determines the exact location, speed, and direction of travel of vehicle 700 using signals from satellites. In some embodiments, the position data collected from GPS 718 is used to determine the location of hazards and is shared with other nearby drivers or vehicles. In some embodiments, the data collected from the various components of vehicle 700 is transmitted to a cloud navigation service (e.g., cloud navigation system 608 of FIG. 6) to be shared with other nearby vehicles.

In some embodiments, vehicle 700 uses one or more chemical sensors (e.g., electronic noses) (not shown) to detect hazardous gas materials. For example, such advanced sensors are capable of detecting various gases, such as combustible gases (e.g., methane and propane), toxic gases (e.g., chlorine and hydrogen cyanide), and volatile organic compounds (VOCs), which in some embodiments may be classified as hazardous materials. In some embodiments, chemical sensors employ technologies such as electrochemical sensors or photoionization detectors. In some embodiments, multisensory data fusion is used to combine thermal imaging data with input from the other components associated with vehicle 700, such as hyperspectral cameras, regular cameras (e.g., RGB), LiDAR, and chemical sensors, to improve the accuracy and reliability of hazardous material detection. In some embodiments, chemical sensors are used to detect hazardous air conditions. In some embodiments, based at least in part on detecting hazardous air conditions via one or more chemical sensors, the suggested action (e.g., as described in relation to FIGS. 1 and 6) to the AV/ADAS system may be to close the windows of the vehicle or to adjust the vehicle's climate control systems to circulate the air within the cabin of the vehicle, rather than pulling in potentially harmful air from outside of the vehicle.

In some embodiments, vehicle 700 integrates one or more metalens camera devices to dynamically compare the characteristics of a known clean road surface with the road ahead of the vehicle. For example, a metalens camera detects anomalies on a road surface, such as fluid spills or wet patches. A metalens camera uses a metamaterial lens to focus light instead of traditional glass or plastic lenses. Metalenses are typically made from an array of nano-sized structures (often referred to as nanostructures) that manipulate light at the nanometer scale. In some embodiments, the system uses the metalens camera to capture and store baseline polarization images of a road under normal, hazard-free conditions. For example, baseline data may be stored in a database, such as database 112 of FIG. 1. For example, the system may create a reference dataset that represents the typical polarization signature of a clean road surface. In some embodiments, as vehicle 700 moves forward, the metalens camera continuously captures real-time images of the road ahead of the vehicle, allowing the system to perform an ongoing comparison between the live images and the stored baseline data. In some embodiments, based on detecting deviations in polarization between the baseline and real-time images, the system can identify potential hazards, such as oil or other fluid spills that disrupt the polarization pattern. In some embodiments, implementing one or more metalens cameras is advantageous over one or more IR cameras, because a liquid material may eventually normalize to the temperature of the road surface, resulting in inconclusive IR camera data. For example, the metalens is able to detect a liquid material based on its polarization signature, regardless of its temperature.

In some embodiments, to maintain accuracy in varying conditions, the system periodically updates the baseline reference images by dynamically recalibrating the database of baseline data with recent images of known safe road surfaces that vehicle 700 has just traveled. In some embodiments, dynamic recalibration adapts the baseline polarization data to current lighting, weather, and road conditions, ensuring consistent performance even as the environment changes. In some embodiments, machine learning models trained on various road and hazard conditions are enabled to process the real-time polarization data and identify specific baseline deviations as indicators of particular types of hazards. In some embodiments, the machine learning models are trained to detect and classify distinct polarization patterns associated with fluid spills, wet patches, and other road hazards, thus increasing the accuracy of object detection.

In some embodiments, based on the degree of deviation from the baseline polarization data, the system assigns a confidence level to each detected anomaly. For example, a minor deviation may trigger a low-level alert to the driver, whereas a more substantial deviation may initiate immediate response actions within the ADAS or AV driving systems of vehicle 700 (e.g., as described in relation to FIGS. 1, 5 and 6). In some embodiments, leveraging a metamaterial-based camera system involves integrating polarization-sensitive imaging to detect fluid spills, particularly oil, by analyzing polarization signatures in real time. For example, unlike conventional thermal or RGB cameras, a metalens camera is capable of differentiating between materials based on their unique polarization responses. As a further example, an oil spill on a road surface reflects and polarizes light differently than the surrounding asphalt or other fluids (e.g., water), providing a distinct polarization signature. In some embodiments, the system uses the metalens camera to capture the complete polarization state (Mueller matrix) of the area in front of a vehicle. In some embodiments, continuously monitoring a road's polarization signatures allows the system to detect oil spills, wet patches, or other fluid-based hazards based on predefined polarization characteristics.

FIG. 8 depicts illustrative devices and systems for enabling a vehicle to detect hazardous material and perform an action to avoid an encounter with the hazardous material, in accordance with some embodiments of the disclosure.

FIG. 8 shows generalized embodiments of illustrative user equipment 800 and 801. For example, user equipment 800 may be a smartphone device, a laptop, a tablet, a near-eye display device, an XR device, or any other suitable device. In another example, user equipment 801 may be a motor vehicle, system or device. User equipment 801 may include vehicle 816. Vehicle 816 may be communicatively connected to microphone 817, audio output equipment (e.g., speaker or headphones 814), and display 812. In some embodiments, microphone 817 may receive audio corresponding to a voice of a video conference participant and/or ambient audio data during a video conference. In some embodiments, display 812 may be a television display, a vehicle's infotainment display or a computer display. In some embodiments, vehicle 816 may be communicatively connected to user input interface 810. In some embodiments, user input interface 810 may be a remote-control device. In some embodiments, user input interface 810 also comprises I/O circuitry. Vehicle 816 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 9. In some embodiments, device 800 may comprise any suitable number of sensors (e.g., gyroscope or gyrometer, or accelerometer, etc.), and/or a GPS module (e.g., in communication with one or more servers and/or cell towers and/or satellites) to ascertain a location of device 800. In some embodiments, device 800 comprises a rechargeable battery that is configured to provide power to the components of the device.

Each one of user equipment 800 and user equipment 801 may receive content and data via input/output (I/O) path 802. I/O path 802 may provide content (e.g., broadcast programming, on-demand programming, internet content, content available over a local area network (LAN) or wide area network (WAN), and/or other content) and data to control circuitry 804, which may comprise processing circuitry and storage 808. Control circuitry 804 may be used to send and receive commands, requests, and other suitable data using I/O path 802, which may comprise I/O circuitry. I/O path 802 may connect control circuitry 804 (and specifically the processing circuitry) to one or more communications paths (described below). I/O functions may be provided by one or more of these communications paths, but are shown as a single path in FIG. 8 to avoid overcomplicating the drawing. While vehicle 816 is shown in FIG. 8 for illustration, any suitable computing device having processing circuitry, control circuitry, and storage may be used in accordance with the present disclosure. For example, vehicle 816 may be replaced by, or complemented by, a personal computer (e.g., a notebook, a laptop, a desktop), a smartphone (e.g., device 800), an XR device, a tablet, a network-based server hosting a user-accessible client device, a non-user-owned device, any other suitable device, or any combination thereof.

Control circuitry 804 may be based on any suitable control circuitry such as processing circuitry. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 804 executes instructions for the media application stored in memory (e.g., storage 808). Specifically, control circuitry 804 may be instructed by the media application to perform the functions discussed above and below. In some implementations, processing or actions performed by control circuitry 804 may be based on instructions received from the media application.

In client/server-based embodiments, control circuitry 804 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 8, the instructions may be stored in storage 808, and executed by control circuitry 804 of a device 800.

In some embodiments, the media application may be a client/server application where only the client application resides on device 800, and a server application resides on an external server (e.g., server 904 and/or media content source 902). For example, the media application may be implemented partially as a client application on control circuitry 804 of device 800 and partially on server 904 as a server application running on control circuitry 911. Server 904 may be a part of a local area network with one or more of devices 800, 801 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 904 and/or an edge computing device), referred to as “the cloud.” Device 800 may be a cloud client that relies on the cloud computing capabilities from server 904 to generate personalized engagement options in a VR environment. The client application may instruct control circuitry 804 to generate personalized engagement options in a VR environment.

Control circuitry 804 may include communications circuitry suitable for communicating with a server, edge computing systems and devices, a table or database server, or other networks or servers. The instructions for carrying out the above-mentioned functionality may be stored on a server (which is described in more detail in connection with FIG. 9). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 9). In addition, communications circuitry may include circuitry that enables peer-to-peer communication of user equipment, or communication of user equipment in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of user equipment 800 and user equipment 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 816.

Audio output equipment 814 may be integrated with or combined with display 812. Display 812 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of each one of device 800 and device 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 817 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. Camera 818 may be any suitable video camera integrated with the equipment or externally connected (e.g., one or more IR cameras). Camera 818 may be a digital camera comprising a charge-coupled device (CCD) and/or a complementary metal-oxide semiconductor (CMOS) image sensor. Camera 818 may be an analog camera that converts to digital images via a video card.

The media application may be implemented using any suitable architecture. For example, it may be a stand-alone application wholly implemented on each one of user equipment 800, user equipment 801, vehicle 816 and vehicle 930. In such an approach, instructions of the application may be stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to provide video conferencing functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 804 may allow a user to provide user profile information or may automatically compile user profile information. For example, control circuitry 804 may access and monitor network data, video data, audio data, processing data, participation data from a conference participant profile. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the media application is a client/server-based application. Data for use by a thick or thin client implemented on each one of user equipment 800 and user equipment 801 may be retrieved on-demand by issuing requests to a server remote to each one of user equipment 800 and user equipment 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on device 800. This way, the processing of the instructions is performed remotely by the server while the resulting displays (e.g., that may include text, a keyboard, or other visuals) are provided locally on device 800. Device 800 may receive inputs from the user via input interface 810 and transmit those inputs to the remote server for processing and generating the corresponding displays. For example, device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to device 800 for presentation to the user.

In some embodiments, the media application may be downloaded and interpreted or otherwise run by an interpreter or virtual machine (e.g., run by control circuitry 804 and/or control circuitry 932 of FIG. 9). In some embodiments, the media application may be encoded in the ETV Binary Interchange Format (EBIF), received by control circuitry 804 and/or control circuitry 932 as part of a suitable feed, and interpreted by a user agent running on control circuitry 804. For example, the media application may be an EBIF application. In some embodiments, the media application may be defined by a series of JAVA-based files that are received and run by a local virtual machine or other suitable middleware executed by control circuitry 804 and/or control circuitry 932. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

FIG. 9 depicts devices and systems including a server, a communication network, computing devices, and a vehicle for performing the methods and processes described herein, in accordance with some embodiments of the disclosure.

As shown in FIG. 9, user equipment 907, user equipment 908 and vehicle 930 may be coupled to communication network 909. Communication network 909 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 909) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths, but are shown as a single path in FIG. 9 to avoid overcomplicating the drawing.

Although communications paths are not drawn between user equipment, these devices and vehicles may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 909.

System 900 may comprise media content source 902, one or more servers 904, database 905, and/or one or more edge computing devices. In some embodiments, the media application may be executed at one or more of control circuitry 911 of server 904 and control circuitry 932 of vehicle 930 (and/or control circuitry of user equipment 907 or user equipment 908). In some embodiments, the media content source and/or server 904 may be configured to host or otherwise facilitate video communication sessions between user equipment 907, user equipment 908, vehicle 930 and/or any other suitable user equipment, and/or host or otherwise be in communication (e.g., over network 909) with one or more social network services.

In some embodiments, server 904 may include control circuitry 911 and storage 917 (e.g., RAM, ROM, Hard Disk, Removable Disk, etc.). Storage 917 may store one or more databases. Server 904 may also include an I/O path 912. I/O path 912 may provide video conferencing data, device information, or other data, over a local area network (LAN) or wide area network (WAN), and/or other content and data to control circuitry 911, which may include processing circuitry, and storage 917. Control circuitry 911 may be used to send and receive commands, requests, and other suitable data using I/O path 912, which may comprise I/O circuitry. I/O path 912 may connect control circuitry 911 (and specifically control circuitry) to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 911 executes instructions for an emulation system application stored in memory (e.g., the storage 917). Memory may be an electronic storage device provided as storage 917 that is part of control circuitry 911.

System 900 may comprise one or more vehicles 930 (which may correspond to vehicle 100 of FIG. 1). Vehicle 930 may comprise control circuitry 932, storage 934, communications circuitry 936, vehicle sensors 938, display 939, I/O circuitry 940, GPS module 942, speaker 944, and microphone 946. In some embodiments, control circuitry 932, storage 934, communications circuitry 936, display 939, I/O circuitry 940, speaker 944, and microphone 946 may be implemented in a similar manner as discussed in connection with corresponding components of server 904 and/or user equipment device 908. In some embodiments, communications circuitry 936 may be suitable for communicating with a vehicle application server or other networks or servers or external devices (e.g., via one or more antennas provided on an exterior or interior of vehicle 930) In some embodiments, communications circuitry 936 may be included as part of control circuitry 932. In some embodiments, control circuitry 932 may be configured to detect objects in the path of vehicle 930 using one or more vehicle sensors 938 (e.g., which may be the same as sensor 102 of FIG. 1). In some embodiments, portions of communication circuitry 936 enable communication over a wireless network (e.g., Wi-Fi). In some embodiments, display 539 may correspond to one or more displays of vehicle 100 of FIG. 1.

In some embodiments, GPS module 942 may be in communication with one or more satellites, remote servers or cloud navigation networks to enable vehicle 930 to provide upcoming directions, e.g., recited via speaker 944 and/or provided via display 939, to aid in vehicle navigation. In some embodiments, vehicle 930 is an autonomous vehicle capable of automatically navigating vehicle 930 along a route corresponding to the directions received via GPS module 942. In some embodiments, GPS module 942 is used to help determine the location of vehicle 930 in relation to a hazmat region.

In some embodiments, vehicle sensors 538 may comprise one or more of proximity sensors, ultrasonic sensors, temperature sensors, accelerometers, gyroscopes, pressure sensors, humidity sensors, or any other sensors described herein, and control circuitry 932 may monitor vehicle operations, such as navigation, powertrain, braking, battery, generator, climate control, and other vehicle systems. Such communication systems facilitate exchanging information with external devices, networks, and systems, such as cellular, Wi-Fi, satellite, vehicle-to-vehicle communications, infrastructure communication systems, and other communications technologies. Such vehicle systems may acquire numerous data points per second, and from this data may identify or calculate numerous types of vehicle status data, such as location, navigation, environmental conditions, velocity, acceleration, change in altitude, direction, and angular velocity. In some embodiments, collected data points are used to detect and classify material found on roadways or in the path of vehicle 930. In some embodiments, information collected by vehicle 930 may be utilized by vehicle 930, transmitted to other nearby vehicles and/or transmitted to server 904 for use in performing autonomous or semi-autonomous navigation.

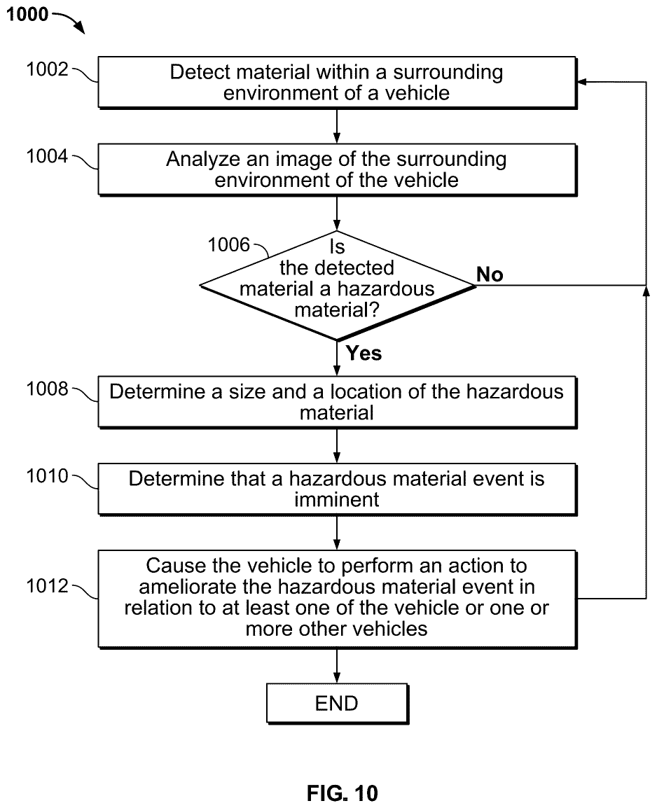

FIG. 10 is a flowchart of the process for detecting hazardous material and performing an action to avoid an encounter with the hazardous material, in accordance with some embodiments of the disclosure. In various embodiments, the individual steps of process 1000 may be implemented by one or more components of the vehicles, systems, devices, and techniques of FIGS. 1-9. Although the present disclosure may describe certain steps of process 1000 (and of other processes described herein) as being implemented by certain components of the devices and software of FIGS. 1-9, this is for purposes of illustration only, and it should be understood that other components of the devices and systems of FIGS. 1-9 may implement those steps instead.

Process 1000 begins at step 1002, where the control circuitry of a vehicle (e.g., control circuitry 804 or 911 of FIGS. 8 and 9, respectively) is configured to detect material on a road surface within the surrounding environment of a vehicle. In some embodiments, the material is material 104 of FIG. 1. For example, the control circuitry of a vehicle may use any combination of camera devices or sensors (e.g., as described in relation to FIGS. 1-7) to detect objects on the surface of a road. In some embodiments, the control circuitry detects objects by using an IR camera device to capture an image of the area in front of the vehicle.

At step 1004, the control circuitry analyzes an image captured by the cameras and sensors of the vehicle. For example, if the control circuitry is using one or more IR camera devices, the captured image may be associated with thermal data. In some embodiments, the control circuitry collects and correlates the data received from camera devices and sensors associated with a vehicle (e.g., vehicle 100 of FIG. 1). For example, the control circuitry may receive a different set of image data from each of an RGB camera, an IR camera, a hyperspectral imaging camera, a metalens camera, a chemical sensor and/or other suitable vehicle sensors. In some embodiments, the control circuitry analyzes captured images in any manner as previously described in relation to FIGS. 1-3.

In some embodiments, at step 1006, the control circuitry determines whether the detected material is a hazardous material. In some embodiments, the control circuitry attempts to identify or classify the detected material by comparing characteristics associated with the material to a database of known materials (e.g., database 112 of FIG. 1). In some embodiments, the control circuitry receives an identification of the detected material based on information received from another vehicle (e.g., via a cloud navigation service such as cloud navigation system 608 of FIG. 6) that has already passed the detected material. In some embodiments, the control circuitry uses neural networks or machine learning algorithms to identify the detected material. In some embodiments, the detected material is identified in any other manner previously described in relation to FIGS. 1-7.

In some embodiments, if the control circuitry determines that the detected material is not hazardous (e.g., the detected material does not pose a serious threat to one or more parts or occupants of the vehicle), process 1000 proceeds back to step 1002, where the control circuitry continues to detect material in the path of the vehicle. Alternatively, if the detected material is determined to be hazardous, process 1000 proceeds to step 1008, where the control circuitry determines the size and location of the hazardous material. For example, the control circuitry may determine the size of the road surface affected by the hazardous material based on the vehicle's distance to the material and the spatial resolution values of the camera devices being used. In some embodiments, the control circuitry determines the size of the hazardous material as described in relation to FIGS. 1 and 3.

In some embodiments, at step 1010, the control circuitry determines that a hazardous material event is imminent. In some embodiments, the control circuitry makes this determination based on determining that the material is hazardous, and the size and the location of the hazardous material. For example, based on the vehicle's current driving data (e.g., speed, direction, tire temperature, etc.), the control circuitry may determine whether the vehicle may experience an encounter with the hazardous material (e.g., a hazardous material event). In some embodiments, the control circuitry determines the hazardous material event based on assessing the potential risk that the material poses to one or more parts or occupants of the vehicle.

In some embodiments, at step 1012, the control circuitry causes the vehicle to perform an action to ameliorate the hazardous material event in relation to at least one of the vehicle or one or more other vehicles, and process 1000 proceeds back to step 1002, where the control circuitry continues to detect additional material in the path of the vehicle. For example, as further described in relation to FIGS. 1 and 3-7, the control circuitry may determine one or more ADAS/AV actions for a vehicle to perform to avoid an encounter with the hazardous material. In some embodiments, the ADAS/AV action is one or more of an alert or warning to the driver of the vehicle that the vehicle is approaching a hazard, a suggested action for the driver to take to avoid the hazard (e.g., lane change, velocity decrease, etc.) or an automatic action to be performed by an AV system. In some embodiments, the ADAS/AV action additionally includes sharing any collected information related to the hazardous situation with one or more cloud navigation services (e.g., cloud navigation system 608 of FIG. 6), which are capable of distributing the information to other nearby drivers or vehicles.

Additionally, while FIGS. 3-7 and 10 provide separate examples of various embodiments of processes, it should be appreciated that one or more of the steps of FIGS. 3-7 and 10 may be performed in combination with each other.

Throughout the specification, the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
detecting, using one or more sensors of a vehicle, material within a surrounding environment of the vehicle;
determining, based at least in part on analyzing an infrared (IR) image of the surrounding environment captured by the one or more sensors, that the material is a hazardous material;
determining a size and a location of the hazardous material within the surrounding environment;
based at least in part on determining that the material is the hazardous material, and the size and the location of the hazardous material, determining a hazardous material event is imminent; and
causing the vehicle to perform an action to ameliorate the hazardous material event in relation to at least one of the vehicle or one or more other vehicles.

2. The method of claim 1, wherein determining that the material is the hazardous material comprises:
extracting material data associated with the material based at least in part on:
identifying thermal data of the IR image, wherein the thermal data is associated with the material; and
obtaining temperature data associated with the material based at least in part on the thermal data;
determining a type of the material based at least in part on comparing the extracted material data to material data for a plurality of material types, wherein the material data is stored in a database and comprises a plurality of signatures respectively corresponding to the plurality of material types; and
based at least in part on determining the type of the material corresponds to a material type in the database that is indicated to be hazardous, determining that the material is the hazardous material.

3. The method of claim 2, wherein comparing the extracted material data to the material data stored in the database comprises:
identifying a plurality of material characteristics indicated by the extracted material data;
determining whether a correspondence between the plurality of material characteristics, indicated by the extracted material data, and a plurality of material characteristics associated with a signature of the material type in the database that is indicated to be hazardous, meets or exceeds a threshold value; and
determining the type of the material corresponds to the material type in the database that is indicated to be hazardous is based at least in part on the correspondence meeting or exceeding the threshold value.

4. The method of claim 1, further comprising:
determining a distance between the hazardous material and the vehicle; and
determining a spatial resolution value of the one or more sensors used to capture the IR image, wherein the size and the location of the hazardous material is determined based at least in part on the distance and the spatial resolution value.

5. The method of claim 1, wherein the action comprises causing output of an alert to an occupant of the vehicle, and wherein causing output of the alert comprises at least one of:
generating for display a suggested driving, steering, or braking action for the occupant to perform in order to avoid an interaction with the hazardous material;
generating for display an augmented visualization of extracted material data associated with the material; or
causing output of at least one of an audio, visual, haptic or textual indication of the hazardous material.

6. The method of claim 1, wherein causing the vehicle to perform the action comprises causing the vehicle to automatically navigate away from the hazardous material.

7. The method of claim 1, further comprising: causing the one or more other vehicles to receive a notification associated with the hazardous material event.

8. The method of claim 7, further comprising:
determining the vehicle is driving through at least a portion of the material;
using the one or more sensors of the vehicle to identify one or more characteristics of the material while the vehicle is driving through the material; and
based at least in part on sensor data received from the one or more sensors of the vehicle, determining the material is a hazardous material.

9. The method of claim 1, wherein determining that the material is the hazardous material comprises providing data indicative of the IR image to a machine learning model, and receiving an output indicating that the material is the hazardous material, wherein the machine learning model is trained at least in part using thermal images.

10. The method of claim 1, wherein determining the material is a hazardous material is further based at least in part on a detected environmental condition of the surrounding environment of the vehicle.

11. The method of claim 1, wherein causing the vehicle to perform the action further comprises:
accessing a dataset of crowdsourced historical data, wherein the dataset comprises indications of a plurality of hazardous materials respectively associated with one or more possible risk conditions; and
determining a level of risk that the hazardous material poses to one or more portions of the vehicle based at least in part on the dataset, the size and the location of the hazardous material.

12. The method of claim 1, further comprising:
transmitting one or more of the IR image, or the size and the location of the hazardous material to one or more navigation systems, wherein the one or more navigation systems provides the one or more of the IR image, or the size and the location of the hazardous material to the one or more other vehicles that are within a threshold vicinity of the vehicle.

13. The method of claim 1, wherein the IR image is captured by an IR camera comprising the one or more sensors, or a hyperspectral camera comprising the one or more sensors.

14. A system comprising:
a memory;
an input/output (I/O) circuitry; and
a control circuitry configured to:
detect, using one or more sensors of a vehicle, material within a surrounding environment of the vehicle;
determine, based at least in part on analyzing an infrared (IR) image of the surrounding environment captured by the one or more sensors, that the material is a hazardous material, wherein the IR image is stored in the memory;
determine a size and a location of the hazardous material within the surrounding environment;
based at least in part on determining that the material is the hazardous material, and the size and the location of the hazardous material, determine a hazardous material event is imminent; and
wherein the I/O circuitry is configured to:
cause the vehicle to perform an action to ameliorate the hazardous material event in relation to at least one of the vehicle or one or more other vehicles.

15. The system of claim 14, wherein the control circuitry is configured to determine that the material is the hazardous material by:
extracting material data associated with the material based at least in part on:
identifying thermal data of the IR image, wherein the thermal data is associated with the material; and
obtaining temperature data associated with the material based at least in part on the thermal data;
determining a type of the material based at least in part on comparing the extracted material data to material data for a plurality of material types, wherein the material data is stored in a database and comprises a plurality of signatures respectively corresponding to the plurality of material types; and
based at least in part on determining the type of the material corresponds to a material type in the database that is indicated to be hazardous, determining that the material is the hazardous material.

16. The system of claim 15, wherein the control circuitry is configured to compare the extracted material data to the material data stored in the database by:
identifying a plurality of material characteristics indicated by the extracted material data;
determining whether a correspondence between the plurality of material characteristics, indicated by the extracted material data, and a plurality of material characteristics associated with a signature of the material type in the database that is indicated to be hazardous, meets or exceeds a threshold value; and
determining the type of the material corresponds to the material type in the database that is indicated to be hazardous is based at least in part on the correspondence meeting or exceeding the threshold value.

17. The system of claim 14, wherein the control circuitry is further configured to:
determine a distance between the hazardous material and the vehicle; and
determine a spatial resolution value of the one or more sensors used to capture the IR image, wherein the size and the location of the hazardous material is determined based at least in part on the distance and the spatial resolution value.

18. The system of claim 14, wherein the action comprises causing output of an alert to an occupant of the vehicle, and wherein the I/O circuitry is configured to cause output of the alert by performing at least one of:
generating for display a suggested driving, steering, or braking action for the occupant to perform in order to avoid an interaction with the hazardous material;
generating for display an augmented visualization of extracted material data associated with the material; or
causing output of at least one of an audio, visual, haptic or textual indication of the hazardous material.

19. The system of claim 14, wherein the I/O circuitry is configured to cause the vehicle to perform the action by causing the vehicle to automatically navigate away from the hazardous material.

20. The system of claim 14, wherein the I/O circuitry is further configured to cause the one or more other vehicles to receive a notification associated with the hazardous material event.

21-65. (canceled)
